(19) United States
(12) Patent Application Publication
(10) Pub. No.: US 2023/0266506 A1
(43) Pub. Date: Aug. 24, 2023

(54) LOUVER FILM, DEVICE, AND MANUFACTURING METHOD THEREOF

(71) Applicant: SAMSUNG ELECTRONICS CO., LTD., Suwon-si (KR)

(72) Inventors: Toshiyuki TAKAHASHI, Yokohama-shi (JP); Atsushi SATO, Yokohama-shi (JP); Yoshihiro YOKOTE, Yokohama-shi (JP); Injo JEONG, Suwon-si (KR); Jeahyuck LEE, Suwon-si (KR); Jongseok YOON, Suwon-si (KR)

(21) Appl. No.: 17/966,889

(22) Filed: Oct. 17, 2022

Related U.S. Application Data
(63) Continuation of application No. PCT/KR2022/014564, filed on Sep. 28, 2022.

(30) Foreign Application Priority Data
Jan. 19, 2022 (JP) 2022-006649

(51) Int. Cl. G02B 1/11

(52) U.S. Cl. CPC G02B 1/11

(57) ABSTRACT

A louver film includes a louver part having a winding structure wherein a laminated body including a light transmittance layer and a light shielding layer is wound, where the louver part includes a light transmittance part defined by the light transmittance layer, and a light shielding part defined by the light shielding layer.

This application is a continuation of International Application No. PCT/KR2022/014564 designating the United States, filed on Sep. 28, 2022, in the Korean Intellectual Property Receiving Office and claiming priority to Japanese Patent Application No. 2022-006649, filed on Jan. 19, 2022, the disclosures of which are incorporated by reference herein in their entireties

### BACKGROUND

### 1. Field

The disclosure relates to a louver film, a device including the louver film, and a manufacturing method of the louver film.

### 2. Description of the Related Art

In a display device, a louver film that can control a range of angles of a penetrating light, for the purpose of granting a peep preventing function, a reflection preventing function, an outdoor visibility improving function, etc., is being used. As a louver film, for example, a film including a louver part that includes a light transmittance part that allows a light to pass therethrough, and a light shielding part that is capable of absorbing and/or reflecting a light incident thereon, which are alternately arranged, is known in the art. Also, as a manufacturing method of a louver film, a method of forming a groove on a light transmittance part and forming a light shielding part in the groove is known in the art. Also, a method of forming a laminated body where a light transmittance layer and a light shielding layer are alternately laminated, and cutting the laminated body in the laminated direction is known in the art. Further, a method of forming a groove on a light transmittance part, and forming a laminated body on which a circular or polygonal film where a light shielding part is formed is laminated in the groove, and cutting the outside perimeter of the laminated body in the laminated direction is known in the art.

### SUMMARY

The structure of a conventional louver film which consists of a light transmittance part, and a light shielding part arranged between the light transmittance part, which are alternately arranged, may be formed with respect to only one direction, and a proceeding direction of a penetrating light is controlled to a specific angle, only with respect to the one direction. However, smart devices such as smartphones, smart watches, tablet terminals, wearable terminals, etc., are typically used from a plurality of directions, and thus a proceeding direction of a penetrating light may not be controlled to a desired angle with respect to a plurality of directions that intersect with the front surface, and accordingly, a desired effect may not be achieved sufficiently.

Accordingly, the disclosure is directed to a louver film having an improved light transmittance rate with respect to a front surface thereof and that can control a range of angles of a penetrating light with respect to a plurality of directions that intersect with the front surface.

In embodiments of the disclosure, a louver film includes a louver part having a winding structure where a laminated body including a light transmittance layer and a light shielding layer is wound, where the louver part includes a light transmittance part defined by the light transmittance layer, and a light shielding part defined by the light shielding layer. In embodiments of the disclosure, a manufacturing method of a louver film including the louver part includes manufacturing a winding body by winding a laminated body including a material layer for a light transmittance layer for forming a light transmittance part, and a material layer for a light shielding layer for forming a light shielding part, and forming a louver part having a winding structure by cutting the winding body in a direction of intersecting with the winding axis direction of the winding body.

According to embodiments of the disclosure, a louver film having an improved light transmittance rate with respect to a front surface thereof and that can control a range of angles of a penetrating light with respect to a plurality of directions that intersect with the front surface thereof may be provided.

### BRIEF DESCRIPTION OF THE DRAWINGS

FIG. 1 is a schematic plan view of a louver film according to an embodiment of the disclosure;

FIG. 2 is a schematic cross-sectional view along A-A line illustrated in FIG. 1;

FIG. 3A is a schematic cross-sectional view of a laminated body which defines a louver part of a louver film according to an embodiment of the disclosure;

FIG. 3B is a schematic perspective view of a winding body which defines a louver film according to an embodiment of the disclosure;

FIG. 4 is a conceptual diagram illustrating a flow of main processes included in a manufacturing method of a louver film according to an embodiment of the disclosure;

FIG. 5 illustrates a schematic diagram illustrating a measurement location of the thickness of a louver film, which is included in a louver film according to an embodiment of the disclosure;

FIG. 6 illustrates a schematic diagram illustrating a measurement location of a total light transmittance rate with respect to a louver film according to an embodiment of the disclosure;

FIG. 7 illustrates a schematic diagram illustrating a measurement location of an angle and a transmittance rate of a penetrating light with respect to a louver film according to an embodiment of the disclosure; and

FIG. 8 illustrates a schematic diagram illustrating a measurement location of an angle and a transmittance rate of a penetrating light with respect to a louver film according to an embodiment of the disclosure.

### DETAILED DESCRIPTION

Hereinafter, embodiments of the disclosure will be described with reference to the accompanying drawings depending on needs. Also, in describing the drawings, same reference numerals will be granted to same elements, and overlapping explanation will be omitted. In addition, proportions of sizes in the drawings may be enlarged for the convenience of explanation, and the proportions may be different from the actual proportions.

Further, unless described particularly differently, manipulations and physical properties, etc. are measured in a condition of the room temperature (20° C. or higher and 25° C. or lower)/relatively humidity of 40%RH or higher and 50%RH or lower).

Embodiments of the disclosure relate to a louver film including a louver part having a winding structure where a laminated body including a light transmittance layer and a light shielding layer is wound, where the louver part includes a light transmittance part defined by the light transmittance layer, and a light shielding part defined by the light shielding layer.

In this specification, ‘a winding structure where a laminated body including a light transmittance layer and a light shielding layer is wound’ refers to a structure that can be achieved in case regarded as a laminated body including a light transmittance layer and a light shielding layer is wound. In the specification of the disclosure, the structure can also refer to a structure described as an example of the winding structure.

For example, in case at least a part of a light transmittance layer exists in a state of a layer-shaped member before a processing for forming the layer (e.g., a curing processing, etc.) before winding, the winding structure may be formed as at least a part of the light transmittance layer is formed through such a processing at the same time as winding, or after winding. For example, in case at least a part of a light shielding layer exists in a state of a layer-shaped member before a processing for forming the layer (e.g., a curing processing, etc.) before winding, the winding structure may be formed as at least a part of the light shielding layer is formed through such a processing at the same time as winding, or after winding. For example, timing of lamination for forming a laminated body including a light transmittance layer and a light shielding layer is not specifically limited, and a laminated structure of a material layer for the light transmittance layer and a material layer for the light shielding layer, which are used for constituting the layers that will be described below, may be formed before winding, or formed at the same time as winding.

In this specification, ‘a louver part including a light transmittance part which has a winding structure where a laminated body including a light transmittance layer and a light shielding layer is wound, and the louver part includes a light transmittance part defined by a light transmittance layer, and a light shielding part defined by a light shielding layer’ is simply referred to as ‘a louver part.’

### Structure of the Louver Film

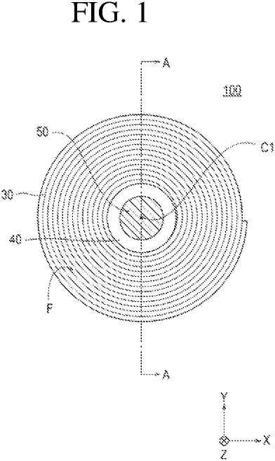

The structure of the louver film 100 according to an embodiment of the disclosure will be described in detail with reference to FIG. 1 to FIG. 3B. FIG. 1 to FIG. 3B relate to a louver film according to an embodiment of the disclosure, and the louver film according to an embodiment of the disclosure is not limited to the structure shown in the drawings.

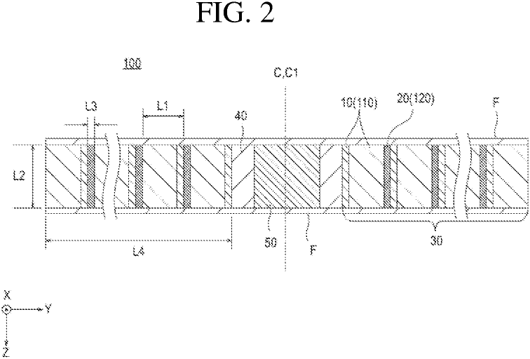

FIG. 1 is a schematic plan view of a louver film according to an embodiment of the disclosure, and FIG. 2 is a schematic cross-sectional view along the A-A line illustrated in FIG. 1. As illustrated in FIG. 1 or FIG. 2, the louver film 100 may include a louver part 30 having a winding structure where a laminated body including a light transmittance layer constituting (or defining) a light transmittance part 10, and a light shielding layer constituting a light shielding part 20 is wound. In the winding structure, the laminated body in a wound state is not specifically limited if it is a laminated body including a light transmittance layer and a light shielding layer. In an embodiment, for example, the laminated body in the wound state may be a laminated body where a light transmittance layer and a light shielding layer are laminated. The louver part 30 of the louver film 100 includes a light transmittance part 10 and a light shielding part 20. The louver part 30 be collectively defined by the light transmittance part 10 and the light shielding part 20. An embodiment of the disclosure includes, for example, a louver part 30 having a winding structure where a laminated body in which a light transmittance layer and a light shielding layer are laminated is wound, and the louver part 30 may be a louver film including a light transmittance part 10 defined by a light transmittance layer, and a light shielding part 20 defined by a light shielding layer. In FIG. 1 and FIG. 2, the reference number 40 refers to a core material that the louver film 100 may randomly include, the reference number 50 refers to a hole part of the core material in a hollow state in case the core material is in a hollow state, and the reference character F refers to a function layer that the louver film may randomly include. FIG. 2 illustrates a case where the light transmittance part 10 has a two-layer structure, and the light shielding part 20 has a single layer structure. However, in the louver film 100, the number of layers constituting the light transmittance part 10 and the light shielding part 20 is not specifically limited. The light transmittance part 10 and the light shielding part 20 may respectively be defined by at least one or two layers.

‘The winding structure where a laminated body including a light transmittance layer and a light shielding layer is wound’ as a structure of the louver film 100 may also be described as a structure where a laminated body including a light transmittance layer having light transmissivity, and a light shielding layer having a light shielding property is wound along a winding axis C which becomes a winding center C1. The winding structure may also be, for example, a structure where only a laminated body including a light transmittance layer and a light shielding layer is wound along the winding axis C as the winding center C1. Also, the winding structure may be a structure where a laminated body including a light transmittance layer and a light shielding layer is wound around the core material 40 along the winding axis C coinciding with the axis direction of the core material 40 as the winding center C1. In an embodiment, the winding structure may be, for example, a winding structure where one laminated body in a long body shape is wound, such that the one laminated body in a long body shape including a light transmittance layer and a light shielding layer is wound in multiple layers in a roll shape. The winding structure illustrated in FIG. 1 and FIG. 2 is an example of a winding structure in the case of using the core material 40. Also, the winding structure may also be a structure where a laminated body including a plurality of light transmittance layers and a plurality of light shielding layers are wound, such that the light transmittance layers and the light shielding layers are arranged alternately with each other in a concentric shape. The end face shape of the longitudinal direction of the laminated body is not specifically limited. In an embodiment, for example, the shape may be a surface shape (a slick plane) that is perpendicular to the long body direction.

The louver part 30 may further include other parts in addition to the light transmittance part 10 and the light shielding part 20. In an embodiment, the louver part 30 may be defined by (or consist of) only the light transmittance part 10 and the light shielding part 20. The louver film 100 may include only the louver part 30, or the louver film 100 may further include other components (e.g., the core material 40 that will be described below, a function layer F shown in FIG. 2 that will be described below, a base material, etc.) in addition to the louver part 30.

The louver film 100 may further include a louver part having another structure other than the louver part 30 described above. In the louver film 100, the louver part 30 may constitute a part of a bigger louver part. However, the louver film 100 may include only the louver part 30 as a louver part thereof.

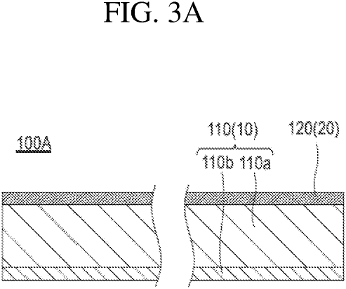

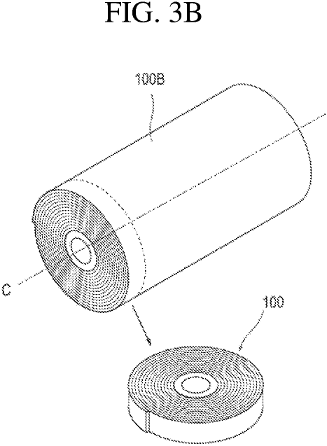

FIG. 3A is a schematic cross-sectional view of a laminated body which defines a louver part of a louver film according to an embodiment of the disclosure, and FIG. 3B is a schematic perspective view of a winding body which defines a louver film according to an embodiment of the disclosure. A manufacturing method of the louver film 100 is not specifically limited, but for example, as illustrated in FIG. 3A, the louver film 100 may be manufactured by a method including manufacturing a laminated body 100A, where a material layer 110 for the light transmittance layer and a material layer 120 for the light shielding layer are at least laminated, winding the laminated body 100A manufactured along the winding axis C as the winding center as illustrated in FIG. 3B and manufacturing a winding body 100B, and cutting the winding body 100B in a specific thickness in a direction intersecting with the winding axis direction. Also, ‘the winding axis’ is an imaginary axis which becomes the winding center C1, and ‘the winding axis direction’ (the direction of the winding axis) coincides with the axial direction of the winding body. For example, as illustrated in FIG. 3B, the winding axis C is an imaginary axis which becomes the winding center of the winding body 100B, and the direction of the winding axis C coincides with the axial direction of the winding body 100B. Based on this, in an embodiment of the disclosure, a louver film 100 that includes a louver part 30 including a light transmittance part 10 and a light shielding part 20 may be manufactured through a winding process of manufacturing a winding body 100B by winding a laminated body including a material layer 110 for the light transmittance layer for forming the light transmittance part 10 (a light transmittance layer), and a material layer 120 for the light shielding layer for forming the light shielding part 20 (a light shielding layer), and a cutting process of forming the louver part 30 by cutting the winding body 100B in a direction intersecting with the winding axis direction of the winding body 100B. Also, in FIG. 3A, the reference number 110a refers to a film for the light transmittance layer constituting the material layer 110 for the light transmittance layer, and the reference number 110b refers to a function layer for the light transmittance layer constituting the material layer 110 for the light transmittance layer, as will be described below. FIG. 3A illustrates a case where the material layer 110 for the light transmittance layer is defined by two layer-shaped members (a film 110a for the light transmittance layer and a function layer 110b for the light transmittance layer), and the material layer 120 for the light shielding layer consists of one layer-shaped member. However, in embodiments of the laminated body 100A, the number of the layer-shaped members constituting the material layer 110 for the light transmittance layer and the material layer 120 for the light shielding layer is not specifically limited. The material layer 110 for the light transmittance layer and the material layer 120 for the light shielding layer may respectively be defined by at least one or two layer-shaped members.

The material layer 110 for the light transmittance layer is a layer-shaped member that is used for forming the light transmittance layer constituting the light transmittance part 10 in the louver part 30 of the louver film 100. The material layer 110 for the light transmittance layer may be used as the light transmittance layer as it is, or it may be used as the light transmittance layer after going through a processing for forming the light transmittance layer. For example, in case at least a part of the material layer 110 for the light transmittance layer is a layer-shaped member before a curing processing, which has curability, the light transmittance layer inside the winding structure may be formed through a curing processing at the same time as winding, or after winding. Based on this, in FIG. 2, the light transmittance part 10 constituting the louver part 30 is also described as the material layer 110 for the light transmittance layer inside the parentheses, and in FIG. 3A, the material layer 110 for the light transmittance layer is also described as the light transmittance part 10 inside the parentheses.

The material layer 120 for the light shielding layer is a layer-shaped member that is used for forming the light shielding layer constituting (or defining) the light shielding part 20 in the louver part 30 of the louver film 100. The material layer 120 for the light shielding layer may be used as the light shielding layer as it is, or it may be used as the light shielding layer after going through a processing for forming the light shielding layer. For example, in case at least a part of the material layer 120 for the light shielding layer is a layer-shaped member before a curing processing, which has curability, the light shielding layer inside the winding structure may be formed through a curing processing at the same time as winding, or after winding. Based on this, in FIG. 2, the light shielding part 20 constituting the louver part 30 is also described as the material layer 120 for the light shielding layer inside the parentheses, and in FIG. 3A, the material layer 120 for the light shielding layer is also described as the light shielding part 20 inside the parentheses.

Regarding the material layer 110 for the light transmittance layer and the material layer 120 for the light shielding layer constituting the laminated body 100A, and other members selectively included, each member may be laminated at the same time as winding, or laminated in advance before winding.

The material layer 110 for the light transmittance layer and the material layer 120 for the light shielding layer constituting the laminated body 100A may respectively be defined by a plurality of members of a specific length, or defined by a single member in a long body shape. Also, the material layer 110 for the light transmittance layer and the material layer 120 for the light shielding layer constituting the laminated body 100A may be constituted as a component having a long body shape by preparing a plurality of members of a specific length, and contacting adjacent end faces thereof to each other. The end face shape of the laminated body 100A in the longitudinal direction in a long body shape is not specifically limited. In an embodiment, for example, the shape may be a surface shape (a slick plane) that is perpendicular to the long body direction.

In the winding structure, the light transmittance layer and the light shielding layer may be laminated while parts thereof overlap with each other, or the layers may be laminated while the entire layers thereof overlap with each other. In the laminated body 100A, the material layer 110 for the light transmittance layer and the material layer 120 for the light shielding layer may be laminated while parts thereof overlap with each other, or the layers may be laminated while the entire light transmittance layer and the entire light shielding layer overlap with each other.

The winding structure of the louver film 100 manufactured may be, for example, a structure that was achieved through winding only the laminated body 100A along the winding axis C as the winding center C1, when winding the laminated body 100A. As the winding structure of the louver film 100, for example, the structure may be a structure that was achieved through using the core material 40, etc., and winding the laminated body 100A around the core material 40 along the winding axis C coinciding with the axis direction of the core material 40 as the winding center C1.

In an embodiment of the disclosure, the louver film 100 includes a louver part 30 having a winding structure where a laminated body including a light transmittance layer and a light shielding layer is wound, and the louver part 30 includes a light transmittance part 10 defined by the light transmittance layer, and a light shielding part 20 defined by the light shielding layer. Based on this, the louver film 100 includes a part where the light transmittance part 10 and the light shielding part 20 are alternately arranged along a direction of proceeding from the winding center C1 toward the outer margin or a circumferential surface (referred to as ‘a radiation direction’ hereinafter) in the plan view of the louver part 30. Also, the meaning of ‘alternately arranged’ is that, between the light transmittance part 10 and the light shielding part 20 arranged along the radiation direction, another part may exist, or another part may not exist. In an embodiment of the louver part 30 of the louver film 100, the light transmittance part 10 and the light shielding part 20 may be arranged alternately with each other in a state where another part does not exist between the light transmittance part 10 and the light shielding part 20.

Hereinafter, embodiments having the above-described structure will be described in detail. In an embodiment of the louver part 30 of the louver film 100, when viewing in a plurality of radiation directions, the light transmittance part 10 and the light shielding part 20 are alternately arranged with each other in the radiation direction viewed. Based on this, the louver film 100 can control a range of angles of a light that passes through the surface (the top surface) or the rear face (the bottom surface) of the film. Because of this, it becomes possible that the louver film 100 secures a property of controlling a range of angles of a penetrating light with respect to a plurality of directions intersecting with the front surface. For example, as illustrated in FIG. 1, in the louver film 100 according to an embodiment of the disclosure, when viewing in any radiation direction, the light transmittance part 10 and the light shielding part 20 are alternately arranged in the radiation direction viewed. Based on this, the louver film 100 can control a range of angles of a light that passes through the surface (the top surface) or the rear face (the bottom surface) of the film. Because of this, it becomes possible that the louver film 100 secures a property of controlling a range of angles of a penetrating light with respect to any direction intersecting with the front surface.

As described above, according to an embodiment of the disclosure, a louver film having a high light transmittance rate with respect to the front surface, and that can control a range of angles of a penetrating light with respect to a plurality of directions that intersect with the front surface (e.g., with respect to a plurality of directions, and particularly preferably, with respect to any direction) can be provided.

In the louver part 30 of the louver film 100, the light transmittance layer constituting the winding structure may function as the light transmittance part 10 of the louver part 30, and the light shielding layer constituting the winding structure may function as the light shielding part 20 of the louver part 30. The louver film 100 according to an embodiment of the disclosure may also be described as, for example, a louver film including a louver part 30 having a winding structure where a laminated body including a light transmittance layer and a light shielding layer is wound.

Hereinafter, the louver film 100 and the manufacturing method thereof will be described in greater detail. The description below relates to a louver film according to an embodiment of the disclosure and a manufacturing method according to an embodiment of the disclosure, but the louver film and the manufacturing method thereof according to embodiments of the disclosure are not limited to those described below.

In this specification, the light transmittance part 10 has a function of allowing at least some of lights of at least some visible wavelengths to pass therethrough. The light transmittance part 10 may allow at least some of lights of at least some visible wavelengths in a range of wavelengths of 300 nm or higher and 1000 nm or lower to pass therethrough.

In this specification, the light shielding part 20 has a function of shielding at least some of lights of at least some visible wavelengths. The light shielding part 20 may shield at least some of lights of at least some visible wavelengths in a range of wavelengths of 300 nm or higher and 1000 nm or lower. Shielding of a light by the light shielding part 20 may be by any one of reflection of a light, absorption of a light, or a combination thereof.

The total light transmittance rate of the light transmittance part 10 is not specifically limited, but it is more desired if the rate is higher. In an embodiment, for example, the total light transmittance rate of the light transmittance part 10 may be 70% or higher, may be 75% or higher, or may be 80% or higher. Within these ranges, the light transmittance part 10 shows high light transmissivity within a range of angles of a light passing through the louver film 100.

The total light transmittance rate of the light shielding part 20 is not specifically limited, but it is more desired if the rate is lower. For example, the total light transmittance rate of the light shielding part 20 may be 5% or lower, may be 3% or lower, or may be 1% or lower.

The total light transmittance rates of the light transmittance part 10 and the light shielding part 20 can be evaluated by a test method based on JIS K 7361-1:1997 (standard by Japanese Industrial Standard / Japanese Standards Association), and can be measured by using a haze meter (e.g., NIPPON DENSHOKU INDUSTRIES CO., LTD., model name: NDH-5000W). Also, measurement of the total light transmittance rates of the light transmittance part 10 and the light shielding part 20 can respectively be evaluated, for example, by preparing a test piece that was manufactured identically to the light transmittance part 10 and the light shielding part 20, and has a measurable film area and the same thickness as the light transmittance part 10 and the light shielding part 20.

The width size of the light transmittance part 10 according to a radiation direction of the louver part 30 (the width of the light transmittance part 10 according to a direction of proceeding from the winding center C1 to the outer margin on the plane orthogonal to the thickness direction of the louver part 30, the width L1 of the light transmittance part 10) may be appropriately set according to a range of angles of a penetrating light, which is aimed by the louver film 100. The width L1 of the light transmittance part 10 is not specifically limited, but for example, may be 15 µm or higher. Also, the width L1 of the light transmittance part 10 is not specifically limited, but for example, may be 100 µm or lower. Further, in case the light transmittance part 10 is defined by two or more layers, the width L1 refers to the entire width of them. For example, in FIG. 2, the width L1 of the light transmittance part 10 refers to the size in the Y direction (the left-right direction) in the drawing orthogonal to the height direction of the light transmittance part 10 (the thickness direction of the louver part 30). According to an embodiment of the disclosure, the width L1 of the light transmittance part 10 may be, for example, 15 µm or higher and 100 µm or lower, etc., but the size is not limited thereto.

Depending on the shape of the louver part 30, there is a case where the width L1 of the light transmittance part 10 is different according to a radiation direction viewed. In such a case, the width L1 of the light transmittance part 10 according to at least one radiation direction satisfies the above-described range. In an embodiment, the width L1 of the light transmittance part 10 according to all radiation directions may satisfy the above-described range. Here, when a measured value is in a range, the value is described as satisfying the range.

In an embodiment, the thickness of the light transmittance layer (in case the layer consists of two or more layer-shaped members, the entire thickness of them), and the thickness of the material layer 110 for the light transmittance layer (in case the layer consists of two or more layer-shaped members, the entire thickness of them) are also respectively identical to the above-described range. This is because, there is a case where, depending on the shape of the louver part and a radiation direction viewed, the width L1 of the light transmittance part 10 corresponds to the thickness of the light transmittance layer.

The width size of the light shielding part 20 according to a radiation direction of the louver part 30 (the width of the light shielding part 20 according to a direction of proceeding from the winding center C1 to the outer margin on the plane orthogonal to the thickness direction of the louver part 30, the width L3 of the light shielding part 20) may be appropriately set according to a range of angles of a viewing angle, which is aimed by the louver film 100. The width L3 of the light shielding part 20 is not specifically limited, but may be 20 µm or lower, may be 15 µm or lower, or may be 10 µm or lower. The width L3 of the light shielding part 20 is not specifically limited, but may be 0.01 µm or higher. Also, in case the light shielding part 20 is defined by two or more layers, the width L3 refers to the entire width of them. For example, in FIG. 2, the width L3 of the light shielding part 20 refers to the size in the Y direction (the left-right direction) in the drawing orthogonal to the height direction of the light shielding part 20 (the thickness direction of the louver part 30). According to an embodiment of the disclosure, the width L3 of the light shielding part 20 may be, for example, 0.01 µm or higher and 20 µm or lower, may be 0.01 µm or higher and 15 µm or lower, or may be 0.01 µm or higher and 10 µm or lower, etc., but the size is not limited thereto.

Depending on the shape of the louver part 30, there is a case where the width L3 of the light shielding part 20 is different according to a radiation direction viewed. In such a case, it is preferable that the width L3 of the light shielding part 20 according to at least one radiation direction satisfies the above-described range. in an embodiment, the width L3 of the light shielding part 20 according to all radiation directions may satisfy the above-described range.

The thickness of the light shielding layer (in case the layer consists of two or more layer-shaped members, the entire thickness of them), and the thickness of the material layer 120 for the light shielding layer (in case the layer consists of two or more layer-shaped members, the entire thickness of them) are also respectively identical to the above-described range. This is because, there is a case where, depending on the shape of the louver part and a radiation direction viewed, the width L3 of the light shielding part 20 corresponds to the thickness of the light shielding layer.

In an embodiment of the disclosure, the ratio of the height L2 of the light shielding part 20 corresponding to the thickness of the louver part 30 with respect to the width L1 of the light transmittance part 10 (L2/L1) is not specifically limited, but from the viewpoint of controlling a viewing angle, the ratio may be 0.5 or higher, may be 1.0 or higher, or may be 1.5 or higher. The ratio of the height L2 with respect to the width L1 (L2/L1) may be appropriately set to satisfy the above numerical values, according to a viewing angle which is aimed by the louver film 100. The ratio of the height L2 with respect to the width L1 (L2/L1) is not specifically limited, but if a numerical value of the ratio of the height L2 with respect to the width L1 (L2/L1) becomes bigger, a range of angles of a penetrating light becomes narrower, and accordingly, from the viewpoint of allowing a light to pass through in an angle range to a certain degree, the ratio may be 30 or lower, may be 25 or lower, or may be 20 or lower. For example, in FIG. 2, in the end face according to the thickness direction of the louver film 100, the width L1 of the light transmittance part 10 is the width L1 of the light transmittance part 10 according to a radiation direction of the louver part 30, and the height of the light shielding part 20 is the height size in the Z direction, and it corresponds to the thickness of the louver part 30. According to an embodiment of the disclosure, the ratio of the height L2 with respect to the width L1 (L2/L1) may be, for example, 0.5 or higher and 30 or lower, 1.0 or higher and 25 or lower, 1.5 or higher and 20 or lower, etc., but the ratio is not limited thereto.

Depending on the shape of the louver part 30, there is a case where the ratio of the height L2 of the light shielding part 20 with respect to the width L1 of the light transmittance part 10 (L2/L1) is different according to a radiation direction viewed. In such a case, the ratio of the height L2 of the light shielding part 20 with respect to the width L1 of the light transmittance part 10 (L2/L1) according to at least one radiation direction satisfies the above-described range. In an embodiment, the ratio of the height L2 of the light shielding part 20 with respect to the width L1 of the light transmittance part 10 (L2/L1) according to all radiation directions may satisfy the above-described range.

The width size of the louver film 100 according to a radiation direction of the louver part 30 (the width of the louver part 30 according to a direction of proceeding from the winding center C1 to the outer margin on the plane orthogonal to the thickness direction of the louver part 30, the width L4 of the louver part 30) may be appropriately changed according to the use when the louver part 30 is applied to the device, and is not specifically limited.

The angle constituted by the direction of the winding axis C of the louver part 30 and the plane orthogonal to the thickness direction of the louver part 30 is not specifically limited if the direction of the winding axis C of the louver part 30 and the plane orthogonal to the thickness direction of the louver part 30 is orthogonal to each other. The direction of the winding axis C of the louver part 30 may be a direction orthogonal to the plane orthogonal to the thickness direction of the louver part 30.

The thickness of the louver part 30 of the louver film 100 is not specifically limited if the film can exert a function as the louver film 100, but it is more desirable if disuniformity is smaller, and it is also desirable that the thickness is approximately uniform. In this specification, the feature that the thickness of the louver part 30 is approximately uniform means that disuniformity of the thickness that is generated unintentionally may exist. The thickness of the louver part 30 of the louver film 100 is not specifically limited, but may be 1 µm or higher. Also, the thickness of the louver part 30 of the louver film 100 is not specifically limited, but may be 5,000 µm or lower. For example, in FIG. 2, the thickness of the louver part 30 is the height size of the louver part 30 in the Z direction. According to an embodiment of the disclosure, the thickness of the louver part 30 may be, for example, 1 µm or higher and 5,000 µm or lower, etc., but the size is not limited thereto.

The thickness of the louver part is expressed as an average value of the thicknesses of specific four parts on the louver part based on the winding center C1. With respect to an example of the measurement method, the details will be described in an embodiment.

The number of windings of the winding structure (the number of windings of the laminated body including a light transmittance layer and a light shielding layer in the winding structure) that the louver part 30 of the louver film 100 has may be appropriately changed according to the manufacturing method of the louver film, or the use thereof when mounted on the device, and is not specifically limited. The number of windings of the winding structure that the louver part 30 of the louver film 100 has may be, for example, two windings or higher, for example, five windings or higher. Also, the number of windings of the winding structure that the louver part 30 of the louver film 100 has may be, for example, 100,000 windings or lower. According to an embodiment of the disclosure, the number of windings of the winding structure of the louver part 30 may be, for example, two windings or higher and 100,000 windings or lower, five windings or higher and 100,000 windings or lower, etc. Meanwhile, with respect to the number of windings of the winding structure that the louver part 30 of the louver film 100 has, the desired number of windings may be selected according to the sides, etc. of the device. Based on this, the number of windings of the winding structure that the louver part 30 of the louver film 100 has is not limited to the above ranges, and it may, for example, exceed 100,000 windings.

According to an embodiment of the disclosure, the outer appearance of the louver part 30 from the viewpoint of the plane (the outer appearance of the louver part 30 on the plane orthogonal to the thickness direction of the louver 30) is not specifically limited, but it may be, for example, a circle, an oval shape, a polygon, etc. In case there is a stepped pulley based on the start of the winding or the end of the winding of the laminated body 100A on the outer margin of the louver part 30, determination on the outer appearance of the louver part 30 from the viewpoint of the plane is performed without consideration of this stepped pulley. As a polygon, an approximate polygon of which ambience of the vertex is round may be included. For example, in an embodiment where the outer appearance of the louver part 30 is a quadrangle, the quadrangle may be an approximate quadrangle of which ambience of the vertex is round. In embodiments, the outer appearance may include a circle or a polygon (including an approximate polygon), a quadrangle (including an approximate quadrangle), and a round rectangle (a track shape).

According to an embodiment of the disclosure, the ratio occupied by the area of the light shielding part 20 to the entire area of the surface of the louver part 30 (the plane orthogonal to the thickness direction of the louver part 30) from the viewpoint of the plane of the louver part 30 is not specifically limited. The ratio occupied by the area of the light shielding part 20 may be 50% or lower, may be 30% or lower, may be 25% or lower, or may be 20% or lower (the lower limit exceeding 0%). Within these ranges, the light transmittance rate of the louver film 100 itself is further improved. In case the louver part 30 consists of only the light transmittance part 10 and the light shielding part 20, the entire area of the surface of the louver part 30 becomes the entire area of the light transmittance part 10 and the light shielding part 20. According to an embodiment of the disclosure, the ratio occupied by the area of the light shielding part 20 to the entire area of the surface of the louver part 30 may be, for example, exceeding 0% and 50% or lower, exceeding 0% and 30% or lower, exceeding 0% and 25% or lower, exceeding 0% and 20% or lower, etc., but the ratio is not limited thereto.

According to an embodiment of the disclosure, it is more desired if the total light transmittance rate of the louver film 100 is higher. For example, the total light transmittance rate of the louver film 100 may be 55% or higher, may be 60% or higher, may be 65% or higher, or may be 70% or higher. The total light transmittance rate of the louver film 100 is not specifically limited, but for example, it may be lower than 100%. According to an embodiment of the disclosure, the total light transmittance rate of the louver film 100 may be, for example, 55% or higher and lower than 100%, 60% or higher and lower than 100%, 65% or higher and lower than 100%, 70% or higher and lower than 100%, etc., but the rate is not limited thereto.

The total light transmittance rate of the louver film can be evaluated by a test method based on JIS K 7361-1:1997, and can be measured by using a hazemeter (e.g., NIPPON DENSHOKU INDUSTRIES CO., LTD., model name: NDH-5000W). Also, the total light transmittance rate of the louver film is expressed as an average value of the total light transmittance rates of specific four parts on the louver film. With respect to an example of the measurement method, the details will be described in an embodiment.

In this specification, the half-value angle of the transmittance rate of the louver film 100 is an angle determined as below. The thickness direction (the vertical direction) from the surface of the louver film 100 is designated as 0°, and the transmittance rate (unit: %) in the direction (the 0° direction) is measured. With respect to the angle constituted by this 0° direction and the direction that intersects with this direction and is toward the winding center C1 (exceeding 0° and 80° or lower), the transmittance rate (unit: %) is measured. Also, with respect to the angle constituted by this 0° direction and the direction that intersects with this direction and extends toward the outer margin of the louver film 100 which is opposite to the winding center C1 (-80° or higher and lower than 0°), the transmittance rate (unit: %) is measured. Here, the angle at which the transmittance rate becomes half (the half-value) (unit: %) with respect to the transmittance rate in the direction of the angle 0° (unit: %) is designated as the half-value angle of the transmittance rate (unit: °). Also, with respect to an example of the determination method of the half-value angle of the transmittance rate, the details will be described in an embodiment. The absolute value of the half-value angle of the transmittance rate of the louver film 100 is not specifically limited if an effect of controlling a desired range of angles of a penetrating light can be achieved. in an embodiment, the louver film 100 has a structure where the absolute value of the half-value angle of the transmittance rate becomes exceeding 0° and 50° or lower, a structure where the absolute value of the half-value angle of the transmittance rate becomes exceeding 0° and 45° or lower, or a structure where the absolute value of the half-value angle of the transmittance rate becomes exceeding 0° and 40° or lower.

The half-value angle of the transmittance rate of the louver film can be evaluated by using a backlight and a conoscope which is a product of Autronic Melchers. Also, the details of the evaluation method will be described in an embodiment.

In an embodiment, the constituting material of the light transmittance part 10may be the constituting material of the material layer 110 for the light transmittance layer that will be described below, or a material originated from the constituting material (e.g., a cured product of the constituting material of the material layer 110 for the light transmittance layer, etc.) and the like.

In case at least a part of the material layer 110 for the light transmittance layer has curability, at least a part of the light transmittance part 10 may include or be formed of the material layer 110 for the light transmittance layer before a curing processing, or include or be formed of the material layer 110 for the light transmittance layer after a curing processing. The material layer 110 for the light transmittance layer includes a layer-shaped member having curability, at least a part of the light transmittance part 10 may include or be formed of the layer-shaped member after a curing processing, or a part of the light transmittance part 10 may include or be formed of the layer-shaped member after a curing processing. The layer-shaped member having curability is not specifically limited, but for example, it may be an adhesive layer. That is, the material layer 110 for the light transmittance layer preferably includes an adhesive layer, and the light transmittance part 10 may be a layer obtained as an adhesive layer (an adhesive layer after a curing processing).

The thicknesses of the light transmittance layer and the material layer 110 for the light transmittance layer are not specifically limited if they can exert a function as the louver film 100, but in the respective layers, it is more desired if disuniformity is smaller, and it is particularly desired that the thickness is approximately uniform. In this specification, the feature that the thicknesses of the light transmittance layer and the material layer 110 for the light transmittance layer are approximately uniform means that, in the respective layers, disuniformity of the thickness that is generated unintentionally may exist. In an embodiment, the ranges of the thicknesses of the light transmittance layer and the material layer 110 for the light transmittance layer may respectively be, for example, a range corresponding to the aforementioned range of the width L1 of the light transmittance part 10.

In an embodiment, the constituting material of the light shielding part 20 may be the constituting material of the material layer 120 for the light shielding layer that will be described below, or a material originated from the constituting material (e.g., a cured product of the constituting material of the material layer 120 for the light shielding layer, etc.) and the like.

In case at least a part of the material layer 120 for the light shielding layer has curability, at least a part of the light shielding part 20 may include or be formed of the material layer 120 for the light shielding layer before a curing processing, or include or be formed of the material layer 120 for the light shielding layer after a curing processing. The material layer 120 for the light shielding layer includes a layer-shaped member having curability, or at least a part of the light shielding part 20 may include or be formed of the layer-shaped member after a curing processing.

The thicknesses of the light shielding layer and the material layer 120 for the light shielding layer are not specifically limited if they can exert a function as the louver film 100, but in the respective layers, it is more desirable if disuniformity is smaller, and it is particularly desirable that the thickness is approximately uniform. In this specification, the feature that the thicknesses of the light shielding layer and the material layer 120 for the light shielding layer are approximately uniform means that, in the respective layers, disuniformity of the thickness that is generated unintentionally may exist. In an embodiment, the ranges of the thicknesses of the light shielding layer and the material layer 120 for the light shielding layer may respectively be, for example, a range corresponding to the aforementioned range of the width L3 of the light shielding part 20.

The louver film 100 may further include other members in addition to the above louver part 30. Other members are not specifically limited, but the other members may include, for example, the core material 40, the function layer F, and a base material, etc. that will be described below.

The louver film 100 may further include the core material 40. The core material 40 may, for example, function as a core part that is arranged in the winding center when winding the laminated body 100A, at the time of manufacturing the louver film 100. In an embodiment, the louver film 100 may further include the core material 40, and the winding structure is a structure where the laminated body including the light transmittance layer and the light shielding layer is wound around the core material 40. As the core material 40, a material in a hollow barrel shape or a column shape can be used. The core material 40 may either be transparent or opaque.

The winding structure of the laminated body including the light transmittance layer and the light shielding layer wound around the core material 40 is not specifically limited. For example, the winding structure may be a winding structure where a laminated body in a long body shape is wound around the core material 40, such that the laminated body including a light transmittance layer and a light shielding layer in a long body shape is wound in multiple layers in a roll shape. For example, the winding structure may also be a winding structure where a laminated body including a plurality of light transmittance layers and light shielding layers are wound around the core material 40, such that the light transmittance layers and the light shielding layers are arranged alternately in a concentric shape around the core material 40. In an embodiment, the winding structure may be the winding structure where the laminated body in a long body shape is wound around the core material 40, such that the laminated body including the light transmittance layer and the light shielding layer in a long body shape is wound in multiple layers in a roll shape. Also, this winding structure may be a winding structure where the laminated body in a long body shape is wound around the core material along the winding axis coinciding with the axis direction of the core material as the winding center. The winding structure illustrated in FIG. 1 and FIG. 2 is an example of this winding structure.

The outer appearance of the end face on the plane orthogonal to the axis direction of the core material 40 is not specifically limited, but it may be, for example, a circle, an oval shape, or a polygon, etc. As a polygon, an approximate polygon of which ambience of the vertex is round may be included. For example, as a quadrangle, there may be an approximate quadrangle of which ambience of the vertex is round. In an embodiment, the outer appearance of the end face on the plane orthogonal to the axis direction of the core material 40 may be a circle, a polygon (including an approximate polygon), a quadrangle (including an approximate quadrangle), or a round rectangle (a track shape). In case the core material 40 is in a hollow shape, the hole part 50 of the core material 40 in a hollow shape may be a cavity, or it may be filled with any material. The material filling in the hole part 50 of the core material 40 in a hollow shape is not specifically limited, but there may be, for example, a material identical to that of the function layer F that the louver film 100 may have, which will be described below.

The outer diameter of the end face on the plane orthogonal to the axis direction of the core material 40 (in case it is a shape other than a circle, the maximum diameter) may be appropriately changed according to the manufacturing method of the louver film, or the use thereof when mounted on the device, and is not specifically limited. In case the louver film 100 includes the core material 40, the outer diameter of the core material 40 inside the louver film 100 is not specifically limited, but it may be, for example, a length which is 10% or more with respect to the outer diameter of the louver part 30 (in case it is a shape other than a circle, the maximum diameter). Also, in case the louver film 100 includes the core material 40, the outer diameter of the core material 40 inside the louver film 100 is not specifically limited, but it may be, for example, a length which is 90% or less with respect to the outer diameter of the louver part 30 (in case it is a shape other than a circle, the maximum diameter). According to an embodiment of the disclosure, the outer diameter of the core material 40 inside the louver film 100 may be, for example, 10% or more and 90% or less with respect to the outer diameter of the louver part 30. However, the outer diameter of the core material 40 inside the louver film 100 is not limited to the above range, and it may be appropriately selected according to the constitution of the device, etc. Based on this, the outer diameter of the core material 40 inside the louver film 100 may be, for example, a length of less than 10% with respect to the outer diameter of the louver part 30 (in case it is a shape other than a circle, the maximum diameter), and it may also be, for example, a length exceeding 90% with respect to the outer diameter of the louver part 30 (in case it is a shape other than a circle, the maximum diameter).

The thickness of the core material 40 inside the louver film 100 is not specifically limited, but the thickness of the core material 40 and the thickness of the louver part 30 may be identical to each other, and the thickness of the core material 40 may be, for example, in the aforementioned range of the thickness of the louver part 30.

The louver film 100 may not include the core material 40, and the louver part 30 may have a winding structure where the laminated body including the light transmittance layer and the light shielding layer is wound.

The louver film 100 may include a function layer F that is arranged on a face in one direction or faces in two directions of the louver part 30. Here, ‘being arranged on a face’ indicates that the function layer F may be arranged to directly contact the surface of the louver part, or arranged on the surface of the louver part through another member. in an embodiment, the function layer F may be arranged to directly contact the surface of the louver part. The function layer F may be arranged on a face in one direction or faces in two directions of the louver part 30. In an embodiment, the function layer F is arranged on faces in two directions. The louver film 100 may include a base material. In an embodiment, the function layer F and the base material may respectively pass through at least some of lights of at least some visible wavelengths, when they are of the desired thicknesses. Also, the function layer F and the base material may respectively pass through at least some of lights of at least some visible wavelengths in a range of wavelengths of 300 nm or higher and 1000 nm or lower, when they are of the desired thicknesses. The total light transmittance rates of the function layer F and the base material are not specifically limited, respectively, but it is more desirable if they are higher. The total light transmittance rates of the function layer F and the base material may be 70% or higher, respectively, may be 75% or higher, or may be 80% or higher. Within these ranges, high light transmissivity is exerted within the range of angles of a light penetrating the louver film 100. In case there are a plurality of function layers F, the total light transmittance rate of each layer may satisfy the above ranges. In case there are a plurality of base materials, the total light transmittance rate of each base material may satisfy the above ranges.

The total light transmittance rates of the function layer F and the base material can respectively be evaluated by a test method based on JIS K 7361-1:1997, and can be measured by using a hazemeter (e.g., NIPPON DENSHOKU INDUSTRIES CO., LTD., model name: NDH-5000W).

The function layer F is not specifically limited, but the function layer F may be, for example, a known function layer used in the field of engineering films. In an embodiment, the function layer F may be various kinds of function layers such as a protection layer, an anti-glare layer, an easy adhesion layer, a cohesive layer, an adhesive layer, etc. In an embodiment, the function layer F may be a protection layer.

The thickness of the protection layer (in case a plurality of protection layers are provided, the thickness of each layer) is not specifically limited. The thickness of the protection layer is preferably a thickness that can guarantee a protection function without influencing the transmittance rate of the louver part 30. From the viewpoint of further improving the function as the protection layer, the thickness may be 1 µm or higher, may be 3 µm or higher, or may be 5 µm or higher. Also, from the viewpoint of exerting less influence on the transmittance rate of the louver part 30, the thickness of the protection layer may be 30 µm or lower, may be 25 µm or lower, or may be 20 µm or lower. As According to an embodiment of the disclosure, the thickness of the protection layer may be, for example, 1 µm or higher and 30 µm or lower, 3 µm or higher and 25 µm or lower, 5 µm or higher and 20 µm or lower, etc., but the thickness is not limited thereto. Also, the protection layer is provided on a face on at least one side of the louver part, or the protection layer is provided on faces in two directions.

According to an embodiment of the disclosure, the louver film 100 includes the core material 40 in addition to the louver part 30. According to an alternative embodiment of the disclosure, the louver film 100 includes the core material 40 and the function layer F (e.g., a protection layer) in addition to the louver part 30. According to another alternative embodiment of the disclosure, the louver film 100 includes the core material 40 in a hollow shape, the function layer F (preferably, a protection layer), and the hole part of the core material 40 in a hollow shape in addition to the louver part 30.

Hereinafter, the constituting materials, etc. of each member constituting the louver film 100 will be described.

### Material Layer for the Light Transmittance Layer

The constitution of the material layer 110 for the light transmittance layer constituting the light transmittance layer is not specifically limited. The material layer 110 for the light transmittance layer may be formed of at least one or two layer-shaped members, or be formed of two or more layer-shaped members. In case the material layer 110 for the light transmittance layer is formed of two or more layer-shaped members, a range of angles of a penetrating light can be controlled by adjusting the refractive index of the members constituting these layer-shaped members.

A method of forming layer-shaped members for constituting at least a part of the material layer 110 for the light transmittance layer is not specifically limited, and for example, a known method may appropriately be adopted.

The layer-shaped members constituting the material layer 110 for the light transmittance layer are not specifically limited, but the layer-shaped members may be, for example, a film, a thin film, etc. Among them, the material layer 110 for the light transmittance layer may include a film (in this specification, a film that the material layer 110 for the light transmittance layer may have is also referred to as a film 110a for the light transmittance layer), and a function layer (in this specification, a function layer that the material layer 110 for the light transmittance layer may have is also referred to as a function layer 110b for the light transmittance layer). In the respective film 110a for the light transmittance layer and function layer 110b for the light transmittance layer, control of the film thickness is easy, and thus control of a range of angles of a penetrating light becomes easier. The film 110a for the light transmittance layer is not specifically limited, but a resin film may be used. The function layer 110b for the light transmittance layer is not specifically limited, but for example, various kinds of function layers such as a hard coat layer, an anti-glare layer, an easy adhesion layer, a cohesive layer, an adhesive layer and a cured layer thereof, etc. may be used. The function layer 110b for the light transmittance layer may include a cohesive layer or an adhesive layer from the viewpoint of easiness of forming the winding structure, and robustness and stability of the winding structure, and may include an adhesive layer. According to an embodiment of the disclosure, the material layer 110 for the light transmittance layer includes a resin film and an adhesive layer.

The constituting materials of the material layer 110 for the light transmittance layer are not specifically limited, but may include a resin. In this specification, a resin as the material of the material layer 110 for the light transmittance layer is not specifically limited if it is a resin that can make a light pass through, which is to a degree that, when a layer of the desired thickness is formed, the layer (or the layer that went through a processing for being the light transmittance layer) can become the light transmittance part 10. As the resin of the material of the material layer 110 for the light transmittance layer, for example, a cellulose resin such as cellulose diacetate, cellulose triacetate, etc., a polyester resin such as polyethylene terephthalate (PET), polyethylene naphthalate, etc., a (meth) acryl resin such as polymethyl acrylate, polymethylmethacrylate, a methyl methacrylate/methyl acrylate copolymer, etc., a polyolefin resin such as a polystyrene resin, a polycarbonate resin, polyethylene, polypropylene, an ethylene/propylene copolymer, etc., a cyclic olefin resin such as a cyclo olefin polymer (COP), etc., a polyvinyl chloride resin, a polyamide resin such as nylon, or aromatic polyamide, etc., a polyimide resin, a polylsulfone resin, a polyethersulfone resin, a polyetheretherketone resin, a polyphenylene sulfide resin, a polyvinyl alcohol resin, a polyvinylidene chloride resin, a polyvinyl butyral resin, a polyarylate resin, a polyoxymethylene resin, an epoxy resin, a silicon resin, a polyurethane resin, etc., may be used. In an embodiment, a polyester resin and an epoxy resin may be used, or a PET and an epoxy resin may be used. As the resin, one type may be used solely, or two or more types may be used in combination. In the case of combining two or more types of resins as the material of the material layer 110, these resins may be included in one layer-shaped member, or may be included in different layer-shaped members.

The material layer 110 for the light transmittance layer may further include an additive. The additive is not specifically limited, but for example, known additives used in the field of resin films, the field of optical films, the field of cohesive agents, the field of adhesive agents, and the field of function layers, etc., may be used.

In case the material layer 110 for the light transmittance layer includes the film 110a for the light transmittance layer, the film 110a for the light transmittance layer is not specifically limited, but the material layer 110 may be a resin film. The rein film may be a film including at least one or two types of resins described above as the materials of the material layer 110 for the light transmittance layer above. Among them, as the resin film, a cellulose resin film such as a cellulose diacetate film, a cellulose triacetate film, etc., a polyester resin film such as a polyethylene terephthalate (PET) film, a polyethylene naphthalate film, etc., a (meth) acryl resin film such as a polymethyl acrylate film, a polymethylmethacrylate film, a methyl methacrylate/methyl acrylate copolymer film, etc., a polyolefin resin film such as a polycarbonate resin film, a polyethylene film, a polypropylene film, an ethylene/propylene copolymer film, etc., a cyclic olefin resin film such as a cyclo olefin polymer (COP), etc. may be described above as examples. Among them, a polyester resin film may be used, or a PET film may be used. As these resin films, one type may be used solely, or two or more types may be used in combination.

As the resin film, a product commercially available in the market may be used, or a manufactured product may be used. A product commercially available in the market is not specifically limited. As a product commercially available in the market as a PET film, there may be, for example, the Cosmo Shine® series (e.g., various kinds of film thickness products of the Cosmo Shine® A4360) produced by TOYOBO CO., LTD., etc. As a product commercially available in the market as a cyclic olefin resin film, there may be, for example, the ARTON® series produced by JSR CO., LTD., the ZEONEX® series and the ZEONOR® series produced by Zeon Corporation, etc. As a product commercially available in the market as a (meth) acryl resin film, there may be, for example, the acryl film RT, SO, HI series produced by KURARAY CO., LTD., etc. As a product sold in the market as a TAC film, there may be, for example, UV-50, UV-80, SH-80, TD-80U, TD-TAC, UZ-TAC produced by FUJIFILM Corporation, etc.

In case the material layer 110 for the light transmittance layer includes the function layer 110b for the light transmittance layer, the function layer 110b for the light transmittance layer is not specifically limited, but the material layer 110 for the light transmittance layer may be a layer including at least one or two types of resins described above as the materials of the material layer 110 for the light transmittance layer above. In case the function layer 110b for the light transmittance layer is a cohesive layer or an adhesive layer, the cohesive layer or the adhesive layer may include at least one type of resin selected from a polyvinyl alcohol resin, a (meth) acryl resin such as polymethyl acrylate, polymethylmethacrylate, a methyl methacrylate/methyl acrylate copolymer, etc., an epoxy resin, and a urethane resin. Among them, the function layer 110b for the light transmittance layer may include an epoxy resin. The function layer 110b for the light transmittance layer may include at least one selected from a cohesive layer and an adhesive layer, may be a cohesive layer or an adhesive layer, or may be an adhesive layer. In case the function layer 110b for the light transmittance layer is at least one selected from a cohesive layer and an adhesive layer, the materials forming them are not specifically limited, but for example, a polyvinyl alcohol cohesive agent, an acryl adhesive agent, an epoxy adhesive agent, a urethane adhesive agent, etc. may be used. As these function layers 110b for the light transmittance layer, one type may be used solely, or two or more types may be used in combination.

The function layer 110b for the light transmittance layer may be formed by using a product commercially available in the market, or by using a manufactured product. In the case of forming the function layer 110b for the light transmittance layer, a product commercially available in the market as the material forming the function layer 110b for the light transmittance layer is not specifically limited. As the material forming an adhesive layer which is one type of the function layer 110b for the light transmittance layer, there may be, for example, an epoxy adhesive agent commercially available in the market (e.g., a main agent of the epoxy adhesive agent 1565 and a curing agent D produced by Cemedine Co., Ltd.), etc.

In case the material layer 110 for the light transmittance layer includes a film 110a for the light transmittance layer, the thickness of the film 110a for the light transmittance layer may be in a range that can achieve an effect of controlling a desired angle of a light. A range of the thickness of the film 110a for the light transmittance layer may be, for example, 5 µm or higher, 10 µm or higher, and 15 µm or higher, but is not limited thereto. Also, a range of the thickness of the film 110a for the light transmittance layer may be, for example, 100 µm or lower, 95 µm or lower, 90 µm or lower, and 85 µm or lower, but is not limited thereto. As a range of the thickness of the film 110a for the light transmittance layer according to an embodiment of the disclosure, there may be, for example, 5 µm or higher and 100 µm or lower, 10 µm or higher and 95 µm or lower, 15 µm or higher and 90 µm or lower, 15 µm or higher and 85 µm or lower, etc., but is not limited thereto. In case the material layer 110 for the light transmittance layer includes the function layer 110b for the light transmittance layer, the thickness of the function layer 110b for the light transmittance layer may be in a range that can achieve an effect of controlling a desired angle of a light. A range of the thickness of the function layer 110b for the light transmittance layer may be, for example, exceeding 0 µm and 20 µm or lower, exceeding 0 µm and 15 µm or lower, and exceeding 0 µm and 10 µm or lower, but is not limited thereto. For example, in case a processing (e.g., a curing processing) is needed for constituting at least a part of the light transmittance layer such as an adhesive layer, etc., the thicknesses of them may respectively indicate a value of the thickness in a state after the processing. The thickness of the film 110a for the light transmittance layer and the thickness of the function layer 110b for the light transmittance layer respectively indicate the length of the film 110a for the light transmittance layer in the film thickness direction, and the length of the function layer 110b for the light transmittance layer in the film thickness direction.

### Material Layer for the Light Shielding Layer

The material layer 120 for the light shielding layer may have light absorptiveness, or have light reflectivity, or have a combination thereof. Among them, the material layer 120 for the light shielding layer may be a member having light absorptiveness.

The color of the material layer 120 for the light shielding layer may be a color which can obtain a desired light shielding property, and for example, the color may be black, red, yellow, green, blue, sky blue, etc. In the case of a material having light absorptiveness, the color may be adjusted according to the type and the use amount (the added amount•the contained amount).

The constitution of the material layer 120 for the light shielding layer is not specifically limited. The material layer 120 for the light shielding layer may include at least one or two layer-shaped members, or a single layer-shaped member. A layer-shaped member constituting the material layer 120 for the light shielding layer is not specifically limited, but there may be, for example, a film, a thin film, etc.

A method of forming layer-shaped members for constituting at least a part of the material layer 120 for the light shielding layer is not specifically limited. Layer-shaped members for constituting at least a part of the material layer 120 for the light shielding layer may be formed, for example, by a known method such as a solution casting method, a melting casting method, an application method, a sputtering method, a vapor deposition method, an ion plating method, a chemical vapor deposition (CVD) method, etc.

The material layer 120 for the light shielding layer may have a material having light absorptiveness. A material having light absorptiveness is not specifically limited, but there may be, for example, a coloring agent such as a dye, a pigment, etc. A pigment is not specifically limited, and it may be an organic pigment or an inorganic pigment, and there may be, for example, a known pigment such as carbon black, bengala, iron oxide, titanium oxide, yellow iron oxide, disazo yellow, phthalocyanine blue, etc. A dye is not specifically limited, but there may be, for example, a known dye showing a black color such as C.I. direct black 19, 22, 32, 38, 51, 56, 71, 74, 75, 77, 154, 168, and 171, etc. As a dye, there may be a xanthene-based dye, an azo-based dye, and an aniline-based dye, etc. Also, there may be organic particles colored by a coloring agent or glass beads colored by a coloring agent. A material having light absorptiveness is not specifically limited, but it may be, for example, a colored material such as graphite. As the material having light absorptiveness, one type may be used solely, or two or more types may be used in combination. In the case of combining two or more types of materials having light absorptiveness and using them, these materials may be included in one layer-shaped member, or may be included in different layer-shaped members.

The material layer 120 for the light shielding layer may consist of only a material having light absorptiveness, or it may consist of a material having light absorptiveness and a different material. A different material is not specifically limited, but there may be, for example, a material constituting the material layer 110 for the light transmittance layer described above, etc. For example, there may be a resin described above as an example of the material of the material layer 110 for the light transmittance layer, etc. Also, the material layer 120 for the light shielding layer may further contain an additive. An additive is not specifically limited, but there may be, for example, known additives used in the field of resin films, the field of optical films, the field of cohesive agents, the field of adhesive agents, and the field of function layers, etc. The material layer 120 for the light shielding layer may include a coloring agent (e.g., a pigment, a dye, etc.), and a resin, or may include a pigment and a resin.

The material layer 120 for the light shielding layer may be formed, for example, as the material having light absorptiveness described above is contained in each of the film 110a for the light transmittance layer (e.g., a resin film), and the function layer 110b for the light transmittance layer in the above description of the material layer 110 for the light transmittance layer, in an amount that can realize a desired light shielding property.

The material layer 120 for the light shielding layer may be a film (in this specification, the film that the material layer 120 for the light shielding layer may have is also referred to as a film for the light shielding layer), or it may be a function layer (in this specification, the function layer that the material layer 120 for the light shielding layer may have is also referred to as a function layer for the light shielding layer), or it may be a combination thereof. Among them, the material layer 120 for the light shielding layer may be a function layer for the light shielding layer. The function layer for the light shielding layer is not specifically limited, but there may be, for example, various kinds of colored layers (e.g.,, a black layer) having light absorptiveness such as an ink layer, a hard coat layer having light absorptiveness, an anti-glare layer having light absorptiveness, an easy adhesion layer having light absorptiveness, a cohesive layer having light absorptiveness, and an adhesive layer having light absorptiveness and a cured layer thereof, etc. Among them, the function layer for the light shielding layer may be at least one type of layer selected from an ink layer, a cohesive layer having light absorptiveness, and an adhesive layer having light absorptiveness. Alternatively, the function layer for the light shielding layer is an ink layer (a layer formed with ink, e.g., a layer including a pigment and/or a dye, and a resin, alternatively, a layer including a pigment and/or a resin, etc.). In an alternative embodiment, the function layer for the light shielding layer is a black ink layer (e.g., a layer including a black pigment and/or a black dye, and a resin, and alternatively, a layer including a black pigment and a resin, etc.). In this case, depending on the constitution of the forming materials of these layers, there are many cases where it is possible to form by a method in which control of the film thickness is easy, such as coating, etc. As a result, control of a range of angles of a penetrating light becomes easier. Also, as the thickness of the material layer 120 for the light shielding layer can become much thinner, the width of the light shielding part 20 becomes narrower as a result, and a good light transmittance rate with respect to the front surface in the louver film 100 can be realized. Further, in a device using the louver film 100, it is expected to secure a better performance (luminance•contrast).

The material layer 120 for the light shielding layer may be formed by using a product commercially available in the market, or by using a manufactured product. In the case of forming the material layer 120 for the light shielding layer, a product commercially available in the market used as the material forming the light shielding layer is not specifically limited. As a product commercially available in the market used as the material forming the light shielding layer, there may be, for example, an ink commercially available in the market (e.g., EG Inky (EG-911 INK) produced by Teikoku Printing Inks Mfg. Co., Ltd.), etc.

The thickness of the film for the light shielding layer is not specifically limited, and it may be in a range that can achieve an effect of controlling a desired angle of a light. An example of a range of the thickness of the film for the light shielding layer is identical to the above example of the range of the thickness of the film 110a for the light transmittance layer. The thickness of the function layer for the light shielding layer is not specifically limited, and it may be in a range that can achieve an effect of controlling a desired angle of a light. An example of a range of the thickness of the function layer for the light shielding layer is identical to the above example of the range of the thickness of the function layer 110b for the light transmittance layer. For example, in case a processing (e.g., a curing processing) is needed for constituting at least a part of the light shielding layer such as an adhesive layer, etc., the thicknesses of them may respectively indicate a value of the thickness in a state after the processing.

At least one member selected from the material layer 110 for the light transmittance layer and the material layer 120 for the light shielding layer may include at least one selected from a cohesive agent and an adhesive agent, and alternatively, it includes a cohesive agent or an adhesive layer, and still alternatively, it includes an adhesive agent. By the cohesive layer or the adhesive layer, formation of the winding body 100B becomes easier, and formation of a more robust and stable winding body 100B becomes possible.

### Total Light Transmittance Rates of the Material Layer for the Light Transmittance Layer and the Material Layer for the Light Shielding Layer

The total light transmittance rate of the material layer 110 for the light transmittance layer is not specifically limited, but it is more desirable if it is higher. The total light transmittance rate of the material layer 110 for the light transmittance layer may be, for example, 70% or higher, may be 75% or higher, or may be 80% or higher. With respect to the total light transmittance rate of the material layer 110 for the light transmittance layer, in case the material layer 110 for the light transmittance layer includes two or more layer-shaped members, the total light transmittance rate of each layer-shaped member may satisfy the above ranges. Within these ranges, high light transmissivity is exerted within a range of angles of a light passing through the louver film 100. In this specification, in case at least a part of the material layer 110 for the light transmittance layer is a layer-shaped member before a processing for forming the light transmittance layer (e.g., a curing processing), and at least a part of the light transmittance layer is constituted through such a processing, the total light transmittance rate of the layer-shaped member may indicate a value of the total light transmittance rate in a state after the processing (a state that is deemed identical to the inside of the light transmittance layer).

In case a layer-shaped member constitutes at least a part of the light transmittance layer through a processing for forming the light transmittance layer (e.g., a curing processing), the layer-shaped member may satisfy the above ranges of the total light transmittance rate in both states before and after the processing.

The total light transmittance rate of the material layer 120 for the light shielding layer is not specifically limited, but it is more preferable if it is lower. The total light transmittance rate of the material layer 120 for the light shielding layer may be 5% or lower, may be 3% or lower, or may be 1% or lower. With respect to the total light transmittance rate of the material layer 120 for the light shielding layer, in case the material layer 120 for the light shielding layer includes two or more layer-shaped members, the total light transmittance rate of each layer-shaped member may satisfy ranges corresponding to the above described ranges of the total light transmittance rate of the light shielding part 20. Within these ranges, an effect of controlling an angle of a light passing through the louver film 100 is further improved. In this specification, in case at least a part of the material layer 120 for the light shielding layer is a layer-shaped member before a processing for forming the light shielding layer (e.g., a curing processing), and at least a part of the light shielding layer is constituted through such a processing, the total light transmittance rate of the layer-shaped member may indicate a value of the total light transmittance rate in a state after the processing (a state that is deemed identical to the inside of the light shielding layer).

In case a layer-shaped member constitutes at least a part of the light shielding layer through a processing for forming the light shielding layer (e.g., a curing processing), the layer-shaped member may satisfy the above ranges of the total light transmittance rate in both states before and after the processing.

The total light transmittance rates of the material layer 110 for the light transmittance layer, the material layer 120 for the light shielding layer, and the layer-shaped members included in them can respectively be evaluated by a test method based on JIS K 7361-1:1997, and can be measured by using a hazemeter (e.g., NIPPON DENSHOKU INDUSTRIES CO., LTD., model name: NDH-5000W). The total light transmittance rates of the material layer 110 for the light transmittance layer and the layer-shaped members included in it are respectively values acquired by measuring them with respect to the thickness direction (the film thickness direction of the material layer 110 for the light transmittance layer, the direction which becomes the laminated direction in the laminated body 100A). The total light transmittance rates of the material layer 120 for the light shielding layer and the layer-shaped members included in it are respectively values acquired by measuring them with respect to the thickness direction (the film thickness direction of the material layer 120 for the light shielding layer, the direction which becomes the laminated direction in the laminated body 100A).

In an embodiment, the light transmittance layer constituting the light transmittance part 10 is constituted by using at least one or two layer-shaped members having a total light transmittance rate of 70% or higher (layer-shaped members constituting the material layer 110 for the light transmittance layer) as the material, and the light shielding layer constituting the light shielding part 20 is constituted by using at least one or two layer-shaped members having a total light transmittance rate of 5% or lower (layer-shaped members constituting the material layer 120 for the light shielding layer) as the material, such an embodiment, a range of the total light transmittance rates of the layer-shaped members constituting the material layer 110 for the light transmittance layer (in case two or more layer-shaped members are used as the material, each layer-shaped member) is identical to the above range of the total light transmittance rates of the material layer 110 for the light transmittance layer. In such an embodiment, a range of the total light transmittance rates of the layer-shaped members constituting the material layer 120 for the light shielding layer (in case two or more layer-shaped members are used as the material, each layer-shaped member) is identical to the above range of the total light transmittance rates of the material layer 120 for the light shielding layer. As described above, in case a layer-shaped member constitutes at least a part of an aimed layer through a processing for forming the aimed layer (e.g., a curing processing), the total light transmittance rate of the layer-shaped member may indicate a value of the total light transmittance rate in a state after the processing. Also, the total light transmittance rate of the layer-shaped member is a value acquired by measuring it with respect to the thickness direction of the layer-shaped member (the direction which becomes the laminated direction in the laminated body 100A).

### Core Material

As another member that may be included in the louver film 100, the core material 40 is not specifically limited, and it may be constituted by using a known core material.

The constituting material of the core material 40 is not specifically limited, but a resin may be used. Also, a resin that passes through at least some of lights of at least some visible wavelengths may be used. As a resin as the material of the core material 40, there may be, for example, a cellulose resin such as cellulose diacetate, cellulose triacetate, etc., a polyester resin such as polyethylene terephthalate (PET), polyethylene naphthalate, etc., a (meth) acryl resin such as polymethyl acrylate, polymethylmethacrylate, a methyl methacrylate/methyl acrylate copolymer, etc., a polyolefin resin such as a polystyrene resin, a polycarbonate resin, polyethylene, polypropylene, an ethylene/propylene copolymer, etc., a cyclic olefin resin such as a cyclo olefin polymer (COP), etc., a polyvinyl chloride resin, a polyamide resin such as nylon, or aromatic polyamide, etc., a polyimide resin, a polylsulfone resin, a polyethersulfone resin, a polyetheretherketone resin, a polyphenylene sulfide resin, a polyvinyl alcohol resin, a polyvinylidene chloride resin, a polyvinyl butyral resin, a polyarylate resin, a polyoxymethylene resin, an epoxy resin, a silicon resin, a polyurethane resin, etc. Among them, a (meth) acryl resin and a polycarbonate resin may be used. As the resin, one type may be used solely, or two or more types may be used in combination.

The core material 40 may further include an additive. As an additive, there may be, for example, a known additive used in the field of core materials, etc.

The outer appearance of the end face on the plane orthogonal to the axis direction of the core material 40, and the outer diameter of the end face on the plane orthogonal to the axis direction of the core material 40 (in case it is a shape other than a circle, the maximum diameter) are respectively identical to what was described above. As the core material 40, a material in a hollow barrel shape or a column shape can be applied, as described above.

Also, in case the core material 40 is in a hollow shape, the hollow part may be a cavity, and at least a part of the hole part 50 of the core material 40 in a hollow shape may be filled with any material. For example, the hole part 50 of the core material 40 in a hollow shape may be filled by a material identical to that of the function layer F, which will be described below.

As the core material 40, a product commercially available in the market may be used, or a manufactured product may be used. A product commercially available in the market is not specifically limited, but there may be, for example, an acryl pipe and a polycarbonate pipe that can be purchased from SUGAWARA KOUGEI CO., LTD., etc.

Also, the winding body 100B may be formed by winding the laminated body 100A without using the core material 40.

### Function Layer

As another member that may be included in the louver film 100, the function layer F is not specifically limited, and it may be constituted by using a known function layer. In an embodiment, the function layer F may be a protection layer. A range of the total light transmittance rates of the protection layer is identical to the above-described range of the total light transmittance rates of the function layer F. In case there are a plurality of protection layers, the total light transmittance rate of each layer satisfies the above range. Also, a measurement method of the total light transmittance rate of the protection layer is identical to the above-described measurement method of the total light transmittance rate of the function layer F.

In case the function layer F is a protection layer, the protection layer is not specifically limited, but a resin may be used. As a resin that becomes the material of the protection layer, a resin that passes through at least some of lights of at least some visible wavelengths, when the layer is of the desired thickness, may be used. As a resin that becomes the material of the protection layer, a curable resin may be used, an active energy ray-curable resin may be used, or an ultraviolet ray-curable resin may be used. As a resin as the material of the protection layer, for example, a cellulose resin such as cellulose diacetate, cellulose triacetate, etc., a polyester resin such as polyethylene terephthalate (PET), polyethylene naphthalate, etc., a (meth) acryl resin such as polymethyl acrylate, polymethylmethacrylate, a methyl methacrylate/methyl acrylate copolymer, etc., a polyolefin resin such as a polystyrene resin, a polycarbonate resin, polyethylene, polypropylene, an ethylene/propylene copolymer, etc., a cyclic olefin resin such as a cyclo olefin polymer (COP), etc., a polyvinyl chloride resin, a polyamide resin such as nylon, or aromatic polyamide, etc., a polyimide resin, a polylsulfone resin, a polyethersulfone resin, a polyetheretherketone resin, a polyphenylene sulfide resin, a polyvinyl alcohol resin, a polyvinylidene chloride resin, a polyvinyl butyral resin, a polyarylate resin, a polyoxymethylene resin, an epoxy resin, a silicon resin, a polyurethane resin, etc. may be used. As an ultraviolet ray-curable resin, for example, a (meth) acryl resin, an epoxy resin, a polyurethane resin, etc. may be used. As these resins, one type may be used solely, or two or more types may be used in combination.

The protection layer may further include an additive. An additive is not specifically limited, but there may be, for example, known additives used in the field of resin films, the field of optical films, and the field of function layers, etc.

As the protection layer, a product commercially available in the market may be used, or a manufactured product may be used. In the case of manufacturing the protection layer, a product commercially available in the market used as the material forming the protection layer is not specifically limited, but there may be, for example, an ultraviolet (UV) ray-curable resin SANRAD® TF-01 produced by Sanyo Chemical Industries, Ltd., etc.

### Manufacturing Method of the Louver Film

A manufacturing method of the louver film 100 is not specifically limited. However, as a manufacturing method of the louver film 100 may include a winding process of manufacturing a winding body 100B by winding a laminated body 100A including a material layer 110 for the light transmittance layer, and a material layer 120 for the light shielding layer, and a cutting process of forming the louver part 30 by cutting the winding body 100B in a direction intersecting with the winding axis direction of the winding body 100B. Based on this, another embodiment of the disclosure may relate to a manufacturing method of a louver film including a louver part, which includes a winding process of manufacturing a winding body by winding a laminated body including a material layer for the light transmittance layer for forming the light transmittance part, and a material layer for the light shielding layer for forming the light shielding part, and a cutting process of forming the louver part having a winding structure by cutting the winding body in a direction intersecting with the winding axis direction of the winding body.

The manufacturing method of the louver film 100 may include a process of forming a lamination which forms the laminated body 100A including a material layer 110 for the light transmittance layer, and a material layer 120 for the light shielding layer, before a winding process.

The material layer 110 for the light transmittance layer becomes the light transmittance layer constituting the light transmittance part 10 as it is, or, in case at least a part of it is a layer-shaped member before a processing for forming the light transmittance layer, through such a processing (e.g., a curing processing, etc.). The material layer 120 for the light shielding layer becomes the light shielding layer constituting the light shielding part 20 as it is, or, in case at least a part of it is a layer-shaped member before a processing for forming the light shielding layer, through such a processing (e.g., a curing processing, etc.). Because of this, the louver part 30 of the louver film 100 becomes a component having a winding structure where the laminated body including the light transmittance layer and the light shielding layer is wound.

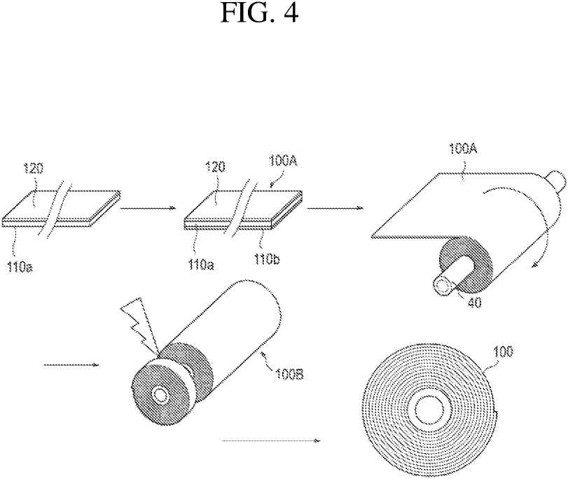

Next, the manufacturing method of the louver film 100 will be described with reference to FIG. 4. FIG. 4 illustrates to a method of manufacturing a louver film according to an embodiment of the disclosure, and the method of manufacturing a louver film according to the disclosure is not limited to those shown in FIG. 4.

### Process of Forming a Laminated Body

The manufacturing method of the louver film 100 may include a process of laminating the material layer 110 for the light transmittance layer, and the material layer 120 for the light shielding layer. In the process, other members may be further laminated in addition to them, but alternatively, only the material layer 110 for the light transmittance layer and the material layer 120 for the light shielding layer are laminated. For example, as illustrated in FIG. 4, first, the material layer 110 for the light transmittance layer and the material layer 120 for the light shielding layer constituting the laminated body 100A are laminated. Alternatively, at least one selected from a cohesive layer and an adhesive layer (e.g., an adhesive layer) is formed, as a part of at least one member selected from the material layer 110 for the light transmittance layer and the material layer 120 for the light shielding layer. As at least one selected from the cohesive layer and the adhesive layer is arranged on a surface in one direction or surfaces in two directions of at least one member selected from the material layer 110 for the light transmittance layer and the material layer 120 for the light shielding layer, cohesiveness or adhesiveness in the laminated body 100A is improved. As a result, formation of the winding body 100B becomes easier, and formation of a more robust and stable winding body 100B becomes possible. Also, in the case of using the core material 40, cohesiveness or adhesiveness between the laminated body 100A and the core material 40, and cohesiveness or adhesiveness in the laminated body 100A is improved, and formation of the winding body 100B becomes easier, and formation of a more robust and stable winding body 100B becomes possible.

A method of forming the laminated body 100A including the material layer 110 for the light transmittance layer and the material layer 120 for the light shielding layer is not specifically limited, and a known method of forming a laminated body according to the constitution may be used.

A manufacturing method of the laminated body 100A is not specifically limited. In case the film 110a for the light transmittance layer constitutes at least a part of the material layer 110 for the light transmittance layer, there may be a method of, for example, forming a function layer for the light shielding layer constituting the material layer 120 for the light shielding layer on one surface of the film 110a for the light transmittance layer, and depending on needs, forming a function layer 110b for the light transmittance layer constituting a part of the material layer 110 for the light transmittance layer on another surface of the film. Also, in case the film for the light shielding layer constitutes at least a part of the material layer 120 for the light shielding layer, a method of, for example, forming a function layer 110b for the light transmittance layer constituting the material layer 110 for the light transmittance layer on one surface of the film for the light shielding layer, and depending on needs, forming a function layer for the light shielding layer constituting a part of the material layer 120 for the light shielding layer on another surface of the film may be used. In an embodiment, as illustrated in FIG. 4, a method of forming a function layer for the light shielding layer which is the material layer 120 for the light shielding layer on one surface of the film 110a for the light transmittance layer constituting a part of the material layer 110 for the light transmittance layer, and forming a function layer 110b for the light transmittance layer constituting a part of the material layer 110 for the light transmittance layer on another surface of the film 110a for the light transmittance layer may be used. Descriptions regarding the film 110a for the light transmittance layer, the function layer 110b for the light transmittance layer, the film for the light shielding layer, and the function layer for the light shielding layer are respectively identical to what is described above.

In case the function layer 110b for the light transmittance layer and the function layer for the light shielding layer are respectively formed, a method of forming a function layer on a film is not specifically limited, and for example, a known method of forming a function layer may be used. As a method of forming the function layer 110b for the light transmittance layer and the function layer for the light shielding layer, there may respectively be, for example, known methods such as a vapor deposition method, a sputtering method, an application method, an ion plating method, a chemical vapor deposition (CVD) method, etc. Among them, an application method such as a coating method, a dipping method, a spraying method, etc. is preferable, and a coating method may be used.

In case the function layer 110b for the light transmittance layer and the function layer for the light shielding layer are respectively formed by an application method, the material forming the function layer 110b for the light transmittance layer and the material forming the function layer for the light shielding layer may be respectively used in the form of a solution or a dispersion. A solvent or a dispersion medium used for a solution or a dispersion is not specifically limited. As a solvent or a dispersion medium, for example, water may be used. Alternatively, for example, an organic solvent such as esters like ethyl acetate, n-Butyl acetate, etc.; aromatic hydrocarbons such as toluene, benzene, etc.; aliphatic hydrocarbons such as n-hexane, n-heptane, etc.; alicyclic hydrocarbons such as cyclohexane, methylcyclohexane, etc.; ketones such as methylethylketone, methyl isobutyl ketone, etc., and the like may be used. Among them, an organic solvent may be used, esters and ketones may be used, or ethyl acetate and methylethylketone may be used. As these solvents or dispersion media, one type may be used solely, or two or more types may be used in combination. The concentrations of the active ingredients of the materials forming the function layer 110b for the light transmittance layer and the function layer for the light shielding layer (the concentrations of the ingredients other than the solvents and the dispersion media) are not specifically limited, respectively, and they may be selected appropriately according to the desired characteristics.

In formation of the function layer 110b for the light transmittance layer by an application method, and formation of the function layer for the light shielding layer by an application method, drying after application of their forming materials, respectively may be performed. A drying method and a drying condition are not specifically limited, and conditions may be selected appropriately.

In an embodiment of the disclosure, the material layer 110 for the light transmittance layer and the material layer 120 for the light shielding layer may respectively be members of a specific length, or may be long bodies. In an embodiment, the material layer 110 for the light transmittance layer and the material layer 120 for the light shielding layer may respectively be long bodies, respectively. Also, in an embodiment of the disclosure, the laminated body 100A including the material layer 110 for the light transmittance layer and the material layer 120 for the light shielding layer may be a long body. The material layer 110 for the light transmittance layer or the material layer 120 for the light shielding layer constituting the laminated body 100A may consist of one member in a long body shape, or it may be formed as a component in a long body shape by preparing a plurality of members having a specific length, and making adjacent end faces contact each other. The end face shape of the longitudinal direction of the laminated body 100A in a long body shape is not specifically limited, but the shape may be a surface shape (a slick plane) that is perpendicular to the long body direction.

### Winding Process

The manufacturing method of the louver film 100 includes a process of manufacturing a winding body 100B by winding a laminated body 100A including a material layer 110 for the light transmittance layer and a material layer 120 for the light shielding layer. As illustrated in FIG. 4C, in the winding process, the laminated body 100A formed in a process of forming a laminated body is wound. The method of forming the winding body 100B is not specifically limited, and for example, a known method of forming a winding body may be used.

As described above, the laminated body 100A including the material layer 110 for the light transmittance layer and the material layer 120 for the light shielding layer may be formed as layers including the material layer 110 for the light transmittance layer and the material layer 120 for the light shielding layer are laminated at the same time as winding, or it may be formed in advance before winding. In the winding process, the laminated body 100A formed in advance before winding where the material layer 110 for the light transmittance layer and the material layer 120 for the light shielding layer are laminated may be wound.

The winding body 100B may include the core material 40, or may not include the core material 40. That is, the winding body 100B may be formed as the laminated body 100A is wound around the core material (the winding core) 40, or it may be formed by winding only the laminated body 100A, without using the core material 40. In an embodiment, the winding body 100B may be formed by winding the laminated body 100A around the core material 40.

A winding method of the laminated body 100A is not specifically limited. In case the laminated body 100A is acquired before winding, there may be a method of, for example, winding the laminated body 100A in a long body shape with respect to the winding center, such that the laminated body 100A in a long body shape is wound in multiple layers in a roll shape. For example, there may be a method of winding a plurality of laminated bodies 100A, such that the plurality of laminated bodies 100A are arranged in a concentric shape with respect to the winding center, etc. In case the laminated body 100A is formed at the same time as winding, there may be a method of, for example, overlapping the material layer 110 for the light transmittance layer in a long body shape and the material layer 120 for the light shielding layer in a long body shape and making a state of the laminated body 100A in a long body shape, and winding the laminated body 100A in a long body shape with respect to the winding center, such that the laminated body 100A in a long body shape is wound in multiple layers in a roll shape. For example, there may be a method of winding a plurality of material layers 110 for the light transmittance layer and a plurality of material layers 120 for the light shielding layer alternately, such that the plurality of material layers 110 for the light transmittance layer and the plurality of material layers 120 for the light shielding layer are alternately arranged in a concentric shape with respect to the winding center, etc.

The laminated body 100A can be easily wound by using the core material 40. A winding method of the laminated body 100A with respect to the core material 40 is not specifically limited. In case the laminated body 100A is acquired before winding, there may be a method of, for example, winding the laminated body 100A in a long body shape around the core material 40, such that the laminated body 100A in a long body shape is wound around the core material 40 in multiple layers in a roll shape. The winding method illustrated in FIG. 4 is an example of this winding method. For example, there may be a method of winding a plurality of laminated bodies 100A around the core material 40, such that the plurality of laminated bodies 100A are arranged in a concentric shape around the core material 40, etc. In case the laminated body 100A is formed at the same time as winding, there may be a method of, for example, overlapping the material layer 110 for the light transmittance layer in a long body shape and the material layer 120 for the light shielding layer in a long body shape and making a state of the laminated body 100A in a long body shape, and winding the laminated body 100A in a long body shape around the core material 40, such that the laminated body 100A in a long body shape is wound in multiple layers in a roll shape. For example, there may be a method of winding a plurality of material layers 110 for the light transmittance layer and a plurality of material layers 120 for the light shielding layer alternately around the core material 40, such that the plurality of material layers 110 for the light transmittance layer and the plurality of material layers 120 for the light shielding layer are alternately arranged in a concentric shape around the core material 40, etc. In these winding methods using the core material 40, the laminated body 100A, or the material layer 110 for the light transmittance layer and the material layer 120 for the light shielding layer are respectively wound around the core material 40, and accordingly, the laminated body 100A is wound around the core material 40.

The winding body 100B may be, for example, a winding body where the laminated body 100A in a long body shape is wound around the core material 40, such that the laminated body 100A in a long body shape is wound in multiple layers in a roll shape, as illustrated in FIG. 4.

In the winding process, a known winding long body may be used. The winding process is not specifically limited. For example, the material layer 110 for the light transmittance layer and the material layer 120 for the light shielding layer may respectively be transferred by a guide roll, etc., and be laminated, and the laminated body 100A may be wound by using a winding roll, etc. For example, the laminated body 100A including the material layer 110 for the light transmittance layer and the material layer 120 for the light shielding layer may be transferred by a guide roll, etc., and may be wound by using a winding roll, etc. In an embodiment, the laminated body 100A where the material layer 110 for the light transmittance layer and the material layer 120 for the light shielding layer were laminated in advance may be transferred by a guide roll, etc., and wound by using a winding roll, etc.

### Cutting Process

The manufacturing method of the louver film 100 includes a process of cutting the winding body 100B acquired in the above winding process in a direction of interesting with the winding axis direction. Through the cutting process, the louver part 30 having a winding structure is formed. A cutting method of the winding body 100B acquired in the above winding process is not specifically limited, and for example, a known cutting method of a member may be used. As a cutting method of the winding body 100B, there may be, for example, methods of using a hand saw, a saw, a cutter, a trimming cutter, a laser, an ultrasonic cutter, a water cutter, etc.

The cutting direction is not specifically limited if it is a direction of interesting with the winding axis direction of the winding body acquired in the above winding process. In an embodiment, the cutting direction may be a direction orthogonal to the winding axis direction.

By performing cutting a plurality of times with respect to a direction of interesting with the winding axis direction, a plurality of winding bodies after cutting may be acquired from the winding body 100B acquired from the above one winding process. In case the core material 40 is not used in the winding process (in case the winding body 100B does not include the core material 40), as a member after cutting acquired by the cutting process, there may be, for example, the louver part 30. In case the core material 40 is used in the winding process (in case the winding body 100B includes the core material 40), as a member after cutting acquired by the cutting process, there may be, for example, a member defined by the core material 40 and the louver part 30. Here, as the member defined by the core material 40 and the louver part 30, there may be, for example, a member defined by the core material 40, and the louver part 30 having a winding structure where the laminated body after cutting is wound around the core material 40, with the core material 40 as the center. Also, the cutting interval of the winding body 100B is determined appropriately according to the thickness desired by the louver part 30 of the louver film 100.

The manufacturing method of the louver film 100 includes at least ‘a winding process’ and ‘a cutting process’ as described above, and as each process is performed in this order, the louver film 100 can be manufactured. In an embodiment, the manufacturing method of the louver film 100 includes ‘a process of forming a laminated body,’ ‘a winding process,’ and ‘a cutting process,’ and as each process is performed in this order, the louver film 100 is manufactured.

### Other Processes

The manufacturing method of the louver film 100 may further include other processes other than the processes described above. Other processes are not specifically limited. As other processes, there may be, for example, a process of performing a curing processing of the winding body 100B acquired from the above winding process (a curing process), a process of forming a function layer F on at least one cut surface of a member after cutting acquired from the above cutting process (a process of forming a function layer), a process of laminating a base material on at least one surface of a member after cutting acquired from the above cutting process (a process of laminating a base material), etc.

In case at least a part of the material layer 110 for the light transmittance layer is a layer-shaped member before a curing processing having curability, and/or at least a part of the material layer 120 for the light shielding layer is a layer-shaped member before a curing processing having curability, the manufacturing method of the louver film 100 may further include a curing process.

The curing process may be performed on any timing among the time before the process of forming a laminated body, the time between the process of forming a laminated body and the winding process, the time between the winding process and the cutting process, and after the cutting process. In an embodiment, the curing process may be performed between the winding process and the cutting process. In such an embodiment, a subject cut in the cutting process becomes the winding body 100B after the curing processing. The curing process is a part of at least some members selected from the material layer 110 for the light transmittance layer and the material layer 120 for the light shielding layer, and it may be performed in case an adhesive layer exists. A curing method and a curing condition are not specifically limited, and conditions may be selected appropriately.

In the manufacturing method of the louver film 100 according to an embodiment of the disclosure, at least one selected from the material layer 110 for the light transmittance layer and the material layer 120 for the light shielding layer includes a layer-shaped member that has curability, and the manufacturing method further includes a curing process of performing a curing processing of the layer-shaped member having curability in the winding body 100B before the cutting process after the winding process.

The manufacturing method of the louver film 100 may further include a process of forming a function layer F (a process of forming a function layer).

The function layer F (e.g., a protection layer) may be formed on a cut surface in one direction of the member after cutting that was acquired by cutting from the winding body 100B, or formed on cut surfaces in two directions. For example, the function layer F (e.g., a protection layer) may be formed on a cut surface in one direction or cut surfaces in two directions of the member defined by the louver part, or the core material 40 and the louver part 30 having a winding structure where the laminated body after cutting is wound around the core material 40, with the core material 40 as the center. Among them, it is preferable that a protection layer is formed on cut surfaces in two directions of the member after cutting that was acquired by cutting from the winding body 100B.

A method of forming the function layer F (e.g., a protection layer) is not specifically limited, and for example, a known method of forming a function layer may be used. As an arrangement method of a method of forming the function layer F, for example, a vapor deposition method, an application method, etc. Among them, an application method such as an imprinting method, a coating method, a dipping method, a spraying method, etc. is preferable, and an imprinting method may be used. Also, after application, drying may be selectively performed.

Examples of a protection layer and a material forming the protection layer are as described above. In case the material forming the protection layer is an active energy ray-curable resin (e.g., an ultraviolet ray-curable resin), the protection layer may be formed by a method as below. First, on one surface (a cut surface) of the member after cutting that was acquired by cutting from the winding body 100B, a curable resin and a peelable film are laminated such that the curable resin and the peelable film are arranged in this order when viewed from the surface of the member after cutting. Then, an active energy ray is radiated on the side of the peelable film, and the active energy ray-curable resin is cured. Then, depending on needs, the peelable film is peeled, and the protection layer is formed.

The peelable film is not specifically limited, but for example, there may be a known film, etc. As the peelable film, a film suggested regarding the film 110a for the light transmittance layer in the above description of the material layer 110 for the light transmittance layer may be used. As the peelable film, a resin film is preferable, a polyester film is more preferable, and a PET film is further preferable. As the peelable film, a product commercially available in the market may be used, or a manufactured product may be used. A product commercially available in the market is not specifically limited, but there may be, for example, the PET film LumirrorⓇ T60 produced by Toray Industries, Inc., etc.

Also, in case the core material 40 is in a hollow shape, the hollow part may be a cavity, and at the same time as formation of the function layer F (e.g., a protection layer), at least a part of the hole part 50 of the core material 40 in a hollow shape may be filled by the same material as that of the function layer F (e.g., a protection layer).

[Louver Film Including an Optical Element, and a Manufacturing Method thereof]

The louver film 100 may further include an optical element. In an embodiment where the louver film 100 further includes an optical element, the winding structure may include the louver part 30 arranged around the optical element, to enclose the optical element. It may be deemed that in the louver film 100, an optical element is arranged on the inner side of the winding structure that the louver part 30 has, from the viewpoint of the plane. Also, the optical element and the louver part may abut to (or directly contact) each other, or another member may exist between them.

A manufacturing method of the louver film 100 which further includes an optical element, and where the winding structure that the louver part 30 has is arranged so as to enclose the optical element is not specifically limited. For example, a manufacturing method of the louver film 100 may include arranging the winding structure that the louver part 30 has around an optical element, to enclose the optical element. For example, the method may further include arranging the winding structure that the louver part 30 has around an optical element, to enclose the optical element, in the above manufacturing method of the louver film 100. A method of arranging the winding structure that the louver part 30 has around an optical element, to enclose the optical element, is not specifically limited. For example, a method of attaching an optical element manufactured may be performed by a known method. For example, in case the louver film 100 includes the core material 40, a method of patterning by pushing a mold to the core material 40, and making the core material 40 an optical element may be performed. For example, in case the louver film 100 includes the core material 40, there may be a method of patterning by pushing a mold to the material filling the hole part 50 of the core material 40 (in case there is the function layer F, e.g., the same material as the function layer F, or the same material as the protection layer), etc., and making the core material 40 an optical element may be performed.

An optical element is not specifically limited. For example, a known optical element. As specific examples of an optical element, there may be various kinds of lenses such as a spherical lens, an aspheric lens, a micro lens, etc., various kinds of lens arrays such as a spherical lens, an aspheric lens, a micro lens, etc., a prism, a prism array, a diffraction grating, a reflection mirror, a light diffusing plate, an anti-reflection film, a phase difference element, a phase difference compensation element, a polarizing plate, a color filter, a band pass filter, a color conversion element, etc. may be used as the optical element.

### Device, and a Manufacturing Method Thereof

The louver film 100 as above may be used while being included in a device. Based on this, another embodiment of the disclosure relates to a device including the louver film 100. A manufacturing method of a device is not specifically limited, but there may be, for example, a method including mounting the louver film 100 as a part of the device. For example, there may be a method including manufacturing the louver film 100 by the above manufacturing method of the louver film 100, and mounting the louver film 100 as a part of the device. Based on this, another embodiment of the disclosure may be a method which is a manufacturing method of a device, and which includes mounting the louver film 100 as a part of the device. Also, another embodiment of the disclosure may be a method which is a manufacturing method of a device, and which includes manufacturing the louver film 100 by the above manufacturing method, and mounting the louver film 100 as a part of the device. A method of mounting the louver film 100 on a device is not specifically limited, and there may be, for example, a known method of mounting a member on a device, etc.

A device is not specifically limited, but in an embodiment, the device may be a device which has a function of introducing and/or emitting a light, and more preferably, it is a device having a display function. Alternatively, the device may be a smart device such as a smartphone, a smart watch, a tablet terminal, a wearable terminal, etc. Alternatively, the device may be a smart device has a function of managing health information such as photoplethysmography, etc., and in realizing the function, correct sensing is needed. In a PPG device, a method of radiating an LED light, and monitoring a reflective light from a blood vessel and acquiring information such as a pulse, etc. is mainly used. The louver film 100 as above, and the louver film 100 manufactured by the above manufacturing method can control a proceeding direction of a penetrating light to a specific angle with respect to a plurality of directions. Based on this, in this method, a signal to noise ratio (S/N) can be improved by using a prism array and the louver film 100. Also, in this method, the louver film 100 can remove a stray light. As described above, from the viewpoint that more correct information can be acquired, a smart device which can perform measurement in the PPG may include the louver film 100.

### Embodiment

The effect of the disclosure will be described by using the embodiments and the comparative examples below. However, the technical scope of the disclosure is not limited only to the embodiments below.

### Preparation of a Louver Film

### Manufacture of Louver Films No. 1-9

### Process of Forming a Lamination

A transparent film in a long body shape (the PET film Cosmo Shine® A4360, thickness of 38 µm, 50 µm or 75 µm produced by TOYOBO CO., LTD.) was prepared. Also, a black ink (the EG inky (EG-911 INK) produced by Teikoku Printing Inks Mfg. Co., Ltd.) was mixed with ethyl acetate such that the concentration of the powder form becomes 50% by weight, and was stirred, and a coating solution for forming a black layer was acquired. Then, on a surface on one side of the transparent film of the film thickness described in ‘Thickness of the Transparent Film’ in the following Table 1, the coating solution for forming a black layer was coated such that the thickness becomes the dried film thickness described in ‘Thickness of the Black layer’ in the following Table 1 by using a bar coater, and drying was performed for one minute at 80° C., and a black layer was formed. Through such a process, a transparent film in a long body shape and a laminated body of a black layer were acquired.

Then, an epoxy adhesive (the Cemedine® 1565 main agent and a curing agent D produced by Cemedine Co., Ltd.) was mixed in a ratio of the epoxy adhesive: the curing agent D=100:15 (a weight ratio), and the acquired mixture was mixed with methylethylketone such that the concentration of the powder form becomes 80% by weight, and was stirred, and a coating solution for forming an adhesive layer was acquired. On the surface on the transparent film side in the transparent film in a long body shape and the laminated body of a black layer acquired, the coating solution for forming an adhesive layer was coated such that the thickness becomes the film thickness after curing described in ‘Thickness of the Adhesive layer’ in the following Table 1 by using a bar coater, and drying was performed for one minute at 80° C., and an adhesive layer was formed. Through such a process, a laminated body in a long body shape where the adhesive layer, the transparent film, and the black layer were laminated in this order was acquired.

Based on JIS K 7361-1:1997, and by using a hazemeter (e.g., NIPPON DENSHOKU INDUSTRIES CO., LTD., model name: NDH-5000W), the total light transmittance rates of the transparent film, the black layer, and the adhesive layer were respectively measured.

All of the total light transmittance rates of the transparent films of the thickness 38 µm, 50 µm and 75 µm were 90.2%.

The total light transmittance rates of the black layers of the thickness 3 µm, 5 µm, 7 µm, 10 µm, 12 µm and 15 µm were respectively 0.07%, 0.01%, 0.00%, 0.00%, 0.00% and 0.00%.

The total light transmittance rates of the adhesive layers of the thickness 5 µm and 10 µm were respectively 89.7% and 88.9%.

Also, the values of the film thickness of the adhesive layer and the total light transmittance rate are values that were measured after curing in the same condition as the curing of the adhesive layer that will be described below.

From these results, it was identified that the total light transmittance rates of the transparent film and the adhesive layer respectively showed greatly bigger values compared to the total light transmittance rate of the black layer, and in the laminated body in a long body shape where the adhesive layer, the transparent film, and the black layer were laminated in this order, the laminated part of the adhesive layer and the transparent film constitute the material layer for the light transmittance layer, and the black layer constitutes the material layer for the light shielding layer. Accordingly, in the laminated body where the adhesive layer, the transparent film, and the black layer were laminated in this order, the summed-up value of the thickness of the adhesive layer and the thickness of the transparent film becomes the thickness of the material layer for the light transmittance layer, and the thickness of the black layer becomes the thickness of the material layer for the light shielding layer.

### Winding Process

The one laminated body in a long body shape where the adhesive layer, the transparent film, and the black layer acquired in the above were laminated in this order was wound around the core material (a polycarbonate pipe in a hollow barrel shape having an outer diameter of 6 mm purchased from SUGAWARA KOUGEI Co., Ltd.) such that the outer diameter becomes 14 mm, and the adhesive layer is arranged on the core material side, and a winding body was thereby acquired. The acquired winding body includes the core material, and the winding body is a winding body where the one laminated body in a long body shape is wound around the core material, such that the one laminated body in a long body shape is wound in multiple layers in a roll shape. Also, the outer appearance of the end face on the plane orthogonal to the axis direction of the core material is a circle.

### Curing Process

The winding body acquired in the above was put in an oven of 80° C., and the adhesive agent was cured, and a winding body after a curing processing was acquired.

### Cutting Process

The winding body after a curing processing acquired in the above was cut such that the thickness becomes a predefined thickness in a direction orthogonal to the winding axis direction for each core material, by using a rotative microtome RX-860 produced by YAMATO KOHKI INDUSTRIAL CO., LTD., and a member after cutting including the core material and the louver part was acquired.

The acquired louver part has a winding structure where one laminated body in a long body shape is wound around the core material, such that the one laminated body in a long body shape is wound in multiple layers in a roll shape. This winding structure is a winding structure where one laminated body in a long body shape is wound around the core material, with the winding axis coinciding with the axis direction of the core material as the winding center. In the acquired louver part, the transparent film and the adhesive layer after curing are a light transmittance layer, and constitute the light transmittance part, and the black layer is a light shielding layer, and constitutes the light shielding part.

Also, the thickness of the acquired louver part was measured by using a high-precision type thickness gauge produced by Mitutoyo Corporation. More specifically, the thicknesses of specific four parts on the louver part based on the winding center C1 in the member after cutting were measured, and their average value became the thickness of the louver part.

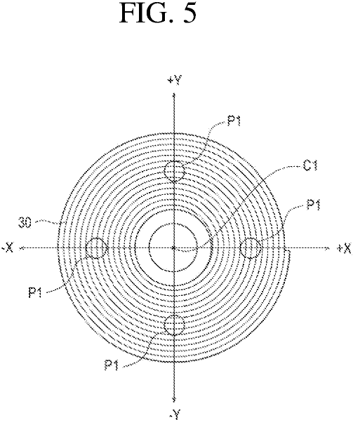

Also, the specific four parts for which thickness measurement was performed were specific four parts on the louver part based on the winding center C1 from the viewpoint of the plane. FIG. 5 is a schematic diagram illustrating a measurement device of the thickness of the louver part included in the louver film according to an embodiment of the disclosure. Regarding the specific four parts for which measurement was performed (a measurement location P1), as illustrated in FIG. 5, an orthogonal coordinate system that passes through the winding center C1 from the viewpoint of the plane in the louver part 30 arranged around the core material was set, and regarding the two axes (the X axis, the Y axis), a location that is toward the outer rim from the intersecting location of the two axes (coinciding with the winding axis C1) by a specific distance was set as a random location on the louver part 30. Also, in the drawing, ‘+X’, ‘-X’, ‘+Y’, and ‘-Y’ respectively indicate directions on the orthogonal coordinate system.

### Process of Forming a Protection Layer

With respect to the cut surfaces in two directions of the member after cutting acquired from the above cutting process, the member after cutting was laminated with an ultraviolet ray-curable resin and a PET film, such that the ultraviolet ray-curable resin (the UV-curable resin Sunred® TF-01 produced by Sanyo Chemical Industries, Ltd.) and the PET film (the PET film LumirrorⓇ T60 produced by Toray Industries, Inc.) were arranged in this order from the side of the member after cutting. Then, from the one PET film side, ultraviolet rays were radiated in a condition of an accumulated light amount of 1000 mJ/cm² (based on 365 nm) by using a metal halide lamp, and the UV-curable resin was cured, and a louver film where the PET film was mounted on two surfaces was thereby formed. Then, the PET film on the two surfaces of the louver film where the PET film was mounted on the two surfaces was separated, and a louver film (a louver film having protection layers on the two surfaces) was completed.

The acquired louver film includes a louver part, a core material, and a protection layer. Also, in the acquired louver film, the hole part of the core material that was a hollow shape before the process of forming a protection layer was in a state of being filled with the same material as the protection layer.

Both of the thicknesses of the protection layers on the two surfaces were 5 µm. The film thickness of the protection layer was calculated as a value which is a result of measuring the thickness of the louver film by the same method as that for the thickness of the louver part above, and subtracting the value of the thickness of the louver part above from this thickness.

Based on JIS K 7361-1:1997, and by using a hazemeter (NIPPON DENSHOKU INDUSTRIES CO., LTD., model name: NDH-5000W), the total light transmittance rate only in the state of the protection layer of 5 µm was measured, and as a result, the total light transmittance rate of the protection layer of 5 µm was 90.8%. Also, the values of the total light transmittance rates of the protection layers are respectively a value acquired by measuring the test material for measurement formed in the same condition for the formation of the protection layers described above.

The configurations of the louver films No. 1-9 are described in the following table 1.

In case the schematic configuration of the louver film acquired in the above is described by using the brief plan view in FIG. 1 and the brief plan view in FIG. 2, the function layer F becomes a protection layer, and the hole part 50 of the core material 40 in a hollow shape is filled by the same material as that for the protection layer. Also, the light transmittance layer constituting the light transmittance part 10 consists of a transparent film and an adhesive layer after curing, and the material layer 110 for the light transmittance layer consists of an adhesive layer and a transparent film. In addition, the light shielding layer constituting the light shielding part 20 consists of a black layer, and the material layer 120 for the light shielding layer consists of a black layer. Also, FIG. 1 and FIG. 2 are schematic diagrams for explanation, and regarding the details of the number of winding in the winding structure in FIG. 1, the locations and the shapes of the beginning of winding or the end of winding in FIG. 1, and the ratios of the sizes of each part in FIG. 1 and FIG. 2, etc., they respectively become configurations according to each louver film that was actually acquired.

### Preparation of the Louver Film No. 10

As the louver film No. 10, a louver film produced by Shin-Etsu Polymer Co., Ltd. (a View Control Film(VCF) Type. model name: VCF1009000-PC200, a laminated type) was prepared. This film has a structure where a light transmittance part and a light shielding part are alternately arranged in parallel with respect to only one direction.

### Evaluation of the Louver Film

[Ratio of the Height (L2) of the Light Shielding Part to the Width L1 of the Light Transmittance Part]

With respect to the louver films No. 1-9 acquired in the above, a ratio of the height (L2) of the light shielding part corresponding to the thickness of the louver part to the width L1 of the light transmittance part according to a direction of proceeding from the winding center C1 to the outer margin on the plane orthogonal to the thickness direction of the louver part (L2/L1) was calculated. Also, with respect to the louver films No. 1-9 acquired in the above, in the state when measuring the film thickness as above, and in the state inside the winding structure of the louver part of the louver film acquired, the film thicknesses of the adhesive layer after curing, the transparent film, and the black layer are respectively almost identical. Based on this, the width L1 of the light transmittance part is the thickness of the light transmittance layer, and coincides with the thickness of the material layer for the light transmittance layer, i.e., the aforementioned summed-up value of the thickness of the adhesive layer and the thickness of the transparent film. The calculation result is described in the following table 1.

[Ratio Occupied by the Area of the Light Shielding Part to the Total Area of the Surface of the Louver Part]

With respect to the louver films No. 1-9 acquired in the above, the ratio (%) occupied by the area of the light shielding part (in the table 1, it is simply described as ‘the ratio occupied by the area of the light shielding part’) to the total area of the surface (the cut surface) of the louver part (the plane orthogonal to the thickness direction of the louver part), from the viewpoint of the plane of the louver part, was calculated. The calculation result is described in the following table 1.

### Measurement of the Total Light Transmittance Rate

### Measurement of the Louver Films No. 1-9

Based on JIS K 7361-1:1997, and by using a hazemeter (NIPPON DENSHOKU INDUSTRIES CO., LTD., model name: NDH-5000W), the total light transmittance rate of the louver film (unit: %) was measured.

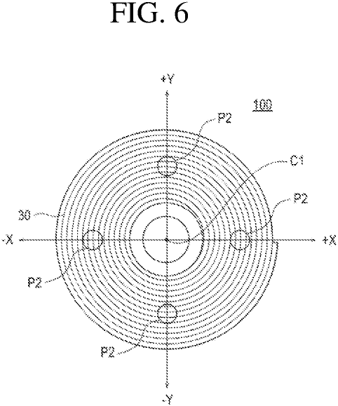

The measurement locations of the louver films No. 1-9 were specific four parts in the location where the louver part exists in the louver film based on the winding center C1 from the viewpoint of the plane. FIG. 6 is a schematic diagram illustrating a measurement location of a total light transmittance rate with respect to a louver film according to an embodiment of the disclosure. Regarding the specific four parts for which measurement was performed (a measurement location P2), as illustrated in FIG. 6, an orthogonal coordinate system that passes through the winding center C1 from the viewpoint of the plane in the louver film 100 including the core material was set, and on the two axes (the X axis, the Y axis), a location that is toward the outer rim from the intersecting location of the two axes (coinciding with the winding axis C1) by a specific distance was set as a random location on the louver part 30. Also, in the drawing, ‘+X’, ‘-X’, ‘+Y’, and ‘-Y’ respectively indicate directions on the orthogonal coordinate system.

Also, as the louver films No. 1-9 have small sizes, for correct measurement, with respect to each of the four parts, the total light transmittance rate (A) of the light shielding film having a hole of 2 mmΦ was measured as the total light transmittance rate, and the louver film was put on the part of the hole, and the total light transmittance rate (B) was measured, and the total light transmittance rate was calculated through a calculation of the total light transmittance rate (unit: %) of the louver film=the total light transmittance rate (B)/the total light transmittance rate (A)×100. Meanwhile, in case the size of the louver film is big, and correct measurement is possible without performing the manipulation and the calculation as above, measurement of the louver film may be performed without using the light shielding film having a hole of 2 mmΦ, and the acquired value may be used as it is as the result of the total light transmittance rate (unit: %) of each part. The average value of the total light transmittance rates of these four parts became the total light transmittance rate (unit: %) of the louver film. The evaluation result is described in the following table 1.

### Measurement of the Louver Film No. 10

Based on JIS K 7361-1:1997, and by using a hazemeter (NIPPON DENSHOKU INDUSTRIES CO., LTD., model name: NDH-5000W), the total light transmittance rate of the louver film (unit: %) was measured.

•Measurement of the Louver Film No. 10 While There Is Only One Film The measurement locations of the louver film No. 10 were specific four parts on the louver film. Also, the specific four parts where measurement of the total light transmittance rate of the louver film No. 10 was performed were determined as follows. In the measurement of the louver film No. 10, the direction where the light transmittance part and the light shielding part of the louver film No. 10 are alternately arranged in parallel (the direction orthogonal to the direction where the light transmittance part and the light shielding part exist to extend to both ends of the film) is referred to as an intersecting arrangement direction. For the measurement location, one direction of the intersecting arrangement direction became the +X direction, and the other direction became the -X direction, and one direction of the direction orthogonal to the intersecting arrangement direction became the +Y direction, and the other direction became the -Y direction, and the measurement location became a location near the center between the center of the film and the end part of the film with respect to these directions.

Also, with respect to the louver film No. 10, the average value of the total light transmittance rates of each part became the total light transmittance rate (unit: %) of the louver film.

The evaluation result of the louver film No. 10 while there is only one film is described in the following table 2.

•Measurement of Two Louver Films No. 10 in a Laminated State Two louver films No. 10 were laminated such that the intersecting arrangement direction of each film becomes vertical. For the measurement location, one direction of the intersecting arrangement direction of the louver film No. 10 arranged on the upper side became the +Y direction, and the other direction became the -Y direction, and one direction of the direction orthogonal to the intersecting arrangement direction of the louver film No. 10 arranged on the upper side became the +X direction, and the other direction became the -X direction, and the measurement location became a location near the center between the center of the film and the end part of the film arranged on the upper side with respect to these directions.

Then, with respect to the two louver films No. 10 in a laminated state, the average value of the total light transmittance rates of each part became the total light transmittance rate (unit: %) of the louver films.

The evaluation result of the two louver films No. 10 in a laminated state is described in the following table 2.

### Measurement of an Angle (a Viewing Angle) and a Light Transmittance Rate of a Penetrating Light

### Measurement of the Louver Films No. 1-9

While there was only a backlight, the backlight was turned on, and an angle (a viewing angle) and a luminance (1) (unit: cd/m²) in each angle of a light were measured by using a Conoscope (produced by Autronic Melchers). Also, the louver film acquired in the above was put on the backlight, and the backlight was turned on, and an angle (a viewing angle) and a luminance (2) (unit: cd/m²) in each angle of a light were measured in the same condition.

Then, with respect to each angle, the transmittance rate (the light transmittance rate) of a light passing through the louver film was calculated through a calculation of the transmittance rate (the light transmittance rate) of a light passing through the louver film (unit: %)=Luminance (2)/Luminance (1)×100.

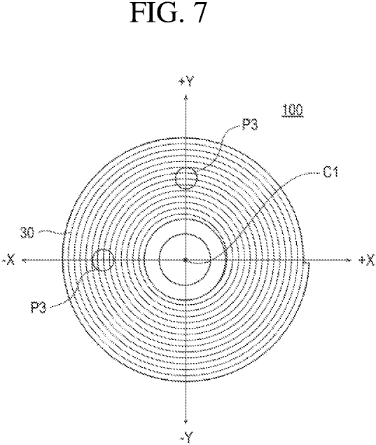

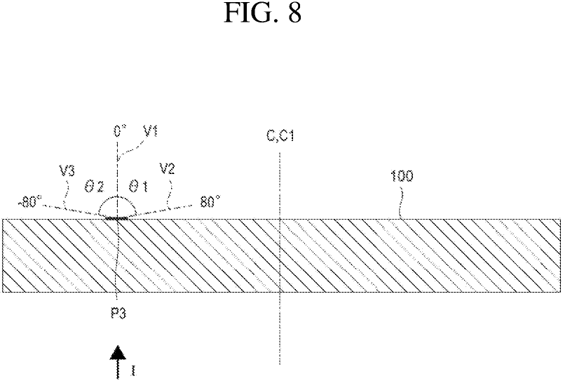

The measurement locations of the louver films No. 1-9 were specific two parts in the location where the louver part exists in the louver film based on the winding center C1 from the viewpoint of the plane. FIG. 7 and FIG. 8 are respectively schematic diagrams illustrating a measurement location of an angle and a transmittance rate of a penetrating light with respect to a louver film according to an embodiment of the disclosure. Regarding the specific two parts for which measurement was performed (a measurement location P3), as illustrated in FIG. 7, an orthogonal coordinate system that passes through the winding center C1 from the viewpoint of the plane in the louver film 100 including the core material was set, and on the two axes (the X axis, the Y axis), a location that is toward the outer rim from the intersecting location of the two axes (coinciding with the winding axis C1) by a specific distance was set as a random location on the louver part 30. Also, in the drawing, ‘+X’, ‘-X’, ‘+Y’, and ‘-Y’ respectively indicate directions on the orthogonal coordinate system.

In these measurement locations, as illustrated in FIG. 8, there is an imaginary line V1 that extends from the plane of the louver film 100 to the thickness direction (the vertical direction). Also, in FIG. 8D, I indicates an incident light. In addition, measurement was performed for the following angles:
0° which is the location of the imaginary line V1;
an angle θ1 constituted by the direction of the imaginary line V1 (the 0° direction), and an imaginary line V2 that intersects with the imaginary line V1 in the measurement location P3 and extends toward the winding center C1 side (the angle θ1 is a plus angle);
an angle θ2 constituted by the direction of the imaginary line V1 (the 0° direction), and an imaginary line V3 that intersects with the imaginary line V1 in the measurement location P3 and extends toward the outer margin side of the louver film 100 which is opposite to the winding center C1 side (the angle θ2 is a minus angle).

Also, the range of angles of the angle θ1 when the location on the imaginary line V1 was 0° was a range of exceeding 0° and 80° or lower, and the range of angles of the angle θ2 when the location on the imaginary line V1 was 0° was a range of -80° or higher and lower than 0°.

That is, the measurement angle was in a range of, when the location on the imaginary line V1 was 0°, ±80° (-80°≤the measurement angleS 80°) with 0° as the center.

When viewed from the winding center C1 illustrated in FIG. 7, the measurement result of the thickness direction (the vertical direction, the 0° direction) of the louver film 100 in the measurement location P3(+Y) in the +Y direction becomes ‘the transmittance rate in the direction of the angle 0° (P3(+Y))’ (unit: %);
When viewed from the winding center C1 illustrated in FIG. 7, the angle θ1 and the angle θ2 of which transmittance rates become a half value (a half value) (unit: %) with respect to ‘the transmittance rate in the direction of the angle 0° (P3(+Y))’ (unit: %) in the measurement location P3(+Y) in the +Y direction become ‘a half value angle of the transmittance rate (P3(+Y))’ (unit: %);
When viewed from the winding center C1 illustrated in FIG. 7, the measurement result of the thickness direction (the vertical direction, the 0° direction) of the louver film 100 in the measurement location P3(-X) in the -X direction becomes ‘the transmittance rate in the direction of the angle 0° (P3(-X))’ (unit: %);
When viewed from the winding center C1 illustrated in FIG. 7, the angle θ1 and the angle θ2 of which transmittance rates become a half value (a half value) (unit: %) with respect to ‘the transmittance rate in the direction of the angle 0° (P3(-X))’ (unit: %) in the measurement location P3(-X) in the -X direction become ‘a half value angle of the transmittance rate (P3(-X))’ (unit: %).

The evaluation result is described in the following table 1.

### Measurement of the Louver Film No. 10

With respect to each of the louver film No. 10 while there is only one film, and the two louver films No. 10 in a laminated state, measurement and calculation of an angle and a transmittance rate of a penetrating light were performed by the same measurement method and the same calculation method as those for the louver films No. 1-9, excluding the determination method of the measurement location and the measurement direction.

In the measurement of the louver film No. 10, the direction where the light transmittance part and the light shielding part of the louver film are alternately arranged in parallel (the direction orthogonal to the direction where the light transmittance part and the light shielding part exist to extend to both ends of the film) is referred to as an intersecting arrangement direction.

•Measurement of the Louver Film No. 10 While There Is Only One Film The measurement location of the louver film No. 10 was a location near the center of the louver film No. 10. In this measurement location, the direction perpendicular to the surface of the louver film No. 10 was the direction of the angle 0°. Also, there was an imaginary line V10 that extends from the surface of the louver film No. 10 in the thickness direction (the vertical direction).

Measurement was performed for the following angles:
0° which is the location of the imaginary line V10;
an angle θ11 constituted by the direction of the imaginary line V10 (the 0° direction) in the measurement location, and an imaginary line V11 that intersects with the imaginary line V10 in the measurement location and extends toward one direction of the direction orthogonal to the intersecting arrangement direction (the direction where the light transmittance part and the light shielding part exist to extend to both ends of the film) (the angle θ11 is a plus angle);
an angle θ12 constituted by the direction of the imaginary line V10 (the 0° direction) in the measurement location, and an imaginary line V12 that intersects with the imaginary line V10 in the measurement location and extends toward the other direction of the direction orthogonal to the intersecting arrangement direction (the angle θ12 is a minus angle);
an angle θ13 constituted by the direction of the imaginary line V10 (the 0° direction) in the measurement location, and an imaginary line V13 that intersects with the imaginary line V10 in the measurement location and extends toward one direction of the intersecting arrangement direction (the angle θ13 is a plus angle);
an angle θ14 constituted by the direction of the imaginary line V10 (the 0° direction) in the measurement location, and an imaginary line V14 that intersects with the imaginary line V10 in the measurement location and extends toward the other direction of the intersecting arrangement direction (the angle θ14 is a minus angle).

Also, the ranges of angles of the angle θ11 and the angle θ13 when the location on the imaginary line V10 was 0° were respectively a range of exceeding 0° and 80° or lower, and the ranges of angles of the angle θ12 and the angle θ14 when the location on the imaginary line V10 was 0° were respectively a range of -80° or higher and lower than 0°.

That is, the measurement angle was in a range of, when the location on the imaginary line V10 was 0°, ±80° (-80°<-the measurement angle≤80°) with 0° as the center, with respect to each of measurement in the intersecting arrangement direction, and measurement in the direction orthogonal thereto.

•Measurement of Two Louver Films No. 10 in a Laminated State In the case of performing measurement of two louver films No. 10 in a laminated state, the two louver films No. 10 were laminated such that the intersecting arrangement direction of each film became vertical. The measurement location of the two louver films No. 10 in a laminated state was a location near the center of the two louver films No. 10 in a laminated state. The direction perpendicular to the surface of the louver film No. 10 arranged on the upper side in the measurement location was the direction of the angle 0°. Also, there was an imaginary line V10 that extends from the surface of the louver film No. 10 arranged on the upper side in the thickness direction (the vertical direction).

Measurement was performed for the following angles:
0° which is the location of the imaginary line V10;
an angle θ11 constituted by the direction of the imaginary line V10 (the 0° direction) in the measurement location, and an imaginary line V11 that intersects with the imaginary line V10 in the measurement location and extends toward one direction of the intersecting arrangement direction of the louver film No. 10 arranged on the upper side (the angle θ11 is a plus angle);
an angle θ12 constituted by the direction of the imaginary line V10 (the 0° direction) in the measurement location, and an imaginary line V12 that intersects with the imaginary line V10 in the measurement location and extends toward the other direction of the intersecting arrangement direction of the louver film No. 10 arranged on the upper side (the angle θ12 is a minus angle);
an angle θ13 constituted by the direction of the imaginary line V10 (the 0° direction) in the measurement location, and an imaginary line V13 that intersects with the imaginary line V10 in the measurement location and extends toward one direction of the direction orthogonal to the intersecting arrangement direction of the louver film No. 10 arranged on the upper side (the angle θ13 is a plus angle);
an angle θ14 constituted by the direction of the imaginary line V10 (the 0° direction) in the measurement location, and an imaginary line V14 that intersects with the imaginary line V10 in the measurement location and extends toward the other direction of the direction orthogonal to the intersecting arrangement direction of the louver film No. 10 arranged on the upper side (the angle θ14 is a minus angle).

Also, the ranges of angles of the angle θ11 and the angle θ13 when the location on the imaginary line V10 was 0° were respectively a range of exceeding 0° and 80° or lower, and the ranges of angles of the angle θ12 and the angle θ14 when the location on the imaginary line V10 was 0° were respectively a range of -80° or higher and lower than 0°.

That is, the measurement angle was in a range of, when the location on the imaginary line V10 was 0°, ±80° (-80°≤the measurement angle≤80°) with 0° as the center, with respect to each of measurement in the intersecting arrangement direction, and measurement in the direction orthogonal thereto of the louver film No. 10 arranged on the upper side.

### Evaluation Items

Evaluation of the louver film No. 10 while there is only one film, and the two louver films No. 10 in a laminated state was performed for the following items:
the measurement result of the thickness direction (the vertical direction, the 0° direction) of the louver film in the measurement location is ‘the transmittance rate in the direction of the angle 0°’ (unit: %);
the angle θ11 and the angle θ12 of which transmittance rates become a half value (a half value) (unit: %) with respect to ‘the transmittance rate in the direction of the angle 0°’ (unit: %) in the measurement location become ‘a half value angle of the transmittance rate (the angle θ11 and the angle θ12)’ (unit: %);
the angle θ13 and the angle θ14 of which transmittance rates become a half value (a half value) (unit: %) with respect to ‘the transmittance rate in the direction of the angle 0°’ (unit: %) in the measurement location become ‘a half value angle of the transmittance rate (the angle θ13 and the angle θ14)’ (unit: %).

The evaluation result is described in the following table 2.

TABLE 1

Configurations of the Louver Films and the Evaluation Result

| | | | | | | | | | | | |
|---|---|---|---|---|---|---|---|---|---|---|---|
| Louver Film Nos. | | | 1 | 2 | 3 | 4 | 5 | 6 | 7 | 8 | 9 |
| Configuration | Thickness of the Transparent Film | (µm) | 38 | 38 | 50 | 75 | 50 | 50 | 50 | 38 | 50 |
| | Thickness of the Adhesive Layer | (µm) | 5 | 5 | 5 | 5 | 5 | 10 | 5 | 5 | 5 |
| | Thickness of the Black Layer | (µm) | 3 | 3 | 3 | 3 | 7 | 3 | 10 | 12 | 15 |
| | Thickness of the Material Layer for the Light Transmittance Layer (Thickness of the Light Transmittance Layer) Thickness of the Material Layer for the Light Shielding Layer (Thickness of the Light Shielding Layer) Thickness of the Louver Part | (µm) | 43 | 43 | 55 | 80 | 55 | 60 | 55 | 43 | 55 |
| | | (µm) | 3 | 3 | 3 | 3 | 7 | 3 | 10 | 12 | 15 |
| | | (µm) | 120 | 75 | 75 | 125 | 130 | 100 | 100 | 75 | 120 |
| Evaluatio n Result | L2/L1 | | 2.8 | 1.7 | 1.4 | 1.6 | 2.4 | 1.7 | 1.8 | 1.7 | 22 |
| | Ratio Occupied by the Area of the Light Shielding Part | (%) | 6.5 | 6.5 | 5.2 | 3.6 | 11.3 | 4.8 | 15.4 | 21.8 | 21.4 |
| | Total Light Transmittance Rate | (%) | 74 | 79 | 82 | 84 | 70 | 80 | 69 | 61 | 64 |
| | Total Light Transmitiance Rate in the Direction of the angle of (PS(Y1) | (%) | 71 | 72 | 75 | 77 | 67 | 74 | 63 | 55 | 58 |
| | Half Value Angle of the Transmitance Rate (PS(Y1) | (°) | ±30 | ±32 | ±40 | +36 | ±25 | ±34 | ±28 | ±32 | ±21 |
| | Total Light Transmittance Rate in the Direction of the angle of (P3(-X) | (%) | 72 | 73 | 76 | 78 | 65 | 75 | 64 | 56 | 57 |
| | Half value Angle of the Transmittance Rate (PS(-X)) | (°) | ±30 | ±31 | ±39 | +36 | ±24 | ±35 | ±29 | ±31 | ±22 |
| Note | | | The Disclosure | The Disclosure | The Disclosure | The Disclosure | The Disclosure | The Disclosure | The Disclosure | The Disclosure | The Disclosure |

| | | | | |
|---|---|---|---|---|
| Louver Film Nos. | | | 10 | 10 (Two Films Laminated ) |
| Configuration | Number of Louver Films | (Steer) | 1 | 2 |
| Evaluation Result | Total Light Transmittance Rate | (%) | 76 | 58 |
| | Transmittence Rate of the Angle 0° | (%) | 75 | 56 |
| | Half Value Angle of the Transmittence Rate (Angles θ11, θ12) | (°) | Cannot Be Identified | ±25 |
| | Half Value Angle of the Transmittence Rate (Angles θ13, θ14) | (°) | ±24 | ±25 |
| Note | | | Comparative Example | Comparative Example |

From the result of the table 1 above, it was confirmed that, according to the louver films No. 1-9 according to an embodiment of the disclosure, a good light transmittance rate with respect to the front surface can be realized, and a range of angles of a penetrating light can be controlled with respect to a plurality of directions. Also, it is deemed that the louver films No. 1-9 according to an embodiment of the disclosure can control a range of angles of a penetrating light with respect to any direction by virtue of their configurations.

Meanwhile, in the louver film No. 10 where there is only one film, a half value angle of the transmittance rate was not identified in a direction orthogonal to the intersecting arrangement direction. That is, a conventional light transmittance part and a conventional light shielding part respectively existed continuously to the opposing end parts of the films. Also, it was confirmed that in the louver film having the louver part in a structure where a light transmittance part and a light shielding part are alternately arranged in parallel only with respect to one direction, it is difficult to control a range of angles of a penetrating light with respect to a plurality of directions.

Further, in case lamination of the louver film No. 1 0 was performed, a range of angles of a penetrating light is controlled with respect to two directions, but it is assumed that such an effect can be acquired only in two directions from the configuration. Also, in case lamination of the louver film No. 10 was performed, it was confirmed that realization of a good light transmittance rate with respect to the front surface becomes difficult. That is, it was confirmed that, in a conventional louver film, even if a plurality of louver films are combined, it is difficult to realize a high light transmittance rate with respect to the front surface, and control a range of angles of a penetrating light with respect to a plurality of directions.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A louver film comprising:
a louver part having a winding structure wherein a laminated body including a light transmittance layer and a light shielding layer is wound,
wherein the louver part comprises:
a light transmittance part defined by the light transmittance layer, and a light shielding part defined by the light shielding layer.

2. The louver film of claim 1,
wherein the light transmittance layer is defined by a layer-shape member, wherein a total light transmittance rate of the light transmittance layer is 70% or higher, and
the light shielding layer is defined by a layer-shape member, wherein a total light transmittance rate of the light shielding layer is 5% or lower.

3. The louver film of claim 1,
wherein a ratio of a height of the light shielding part corresponding to a thickness of the louver part to a width of the light transmittance part according to a direction of proceeding from a winding center to an outer margin on a plane orthogonal to a thickness direction of the louver part is 0.5 or higher.

4. The louver film of claim 1,
wherein a proportion occupied by an area of the light shielding part to a total area of a plane orthogonal to a thickness direction of the louver part is 50% or lower.

5. The louver film of claim 1, further comprising:
a core material,
wherein the winding structure is a structure wherein the laminated body is wound around the core material.

6. The louver film of claim 5,
wherein an outer appearance of a cross-section in a plane orthogonal to an axis direction of the core material is a circle, an oval shape, or a polygon.

7. The louver film of claim 1, further comprising:
an optical element, and
wherein the winding structure included by the louver part is arranged on a periphery of the optical element, to enclose the optical element.

8. A device comprising the louver film of claim 1.

9. A manufacturing method of a louver film including the louver part, the method comprising:
manufacturing a winding body by winding a laminated body including a material layer for a light transmittance layer for forming a light transmittance part, and a material layer for a light shielding layer for forming a light shielding part; and
forming a louver part having a winding structure by cutting the winding body in a direction of intersecting with a winding axis direction of the winding body.

10. The manufacturing method of a louver film of claim 9,
wherein at least one selected from the material layer for the light transmittance layer and the material layer for the light shielding layer includes a layer-shaped member which has curability, and
the manufacturing method further comprises:
performing a curing processing of the layer-shaped member having curability in the winding body before the forming the louver part having the winding structure by cutting after the manufacturing the winding body by winding the laminated body.

11. The manufacturing method of a louver film of claim 9, further comprising:
arranging the winding structure included by the louver part on a periphery of an optical element, to enclose the optical element.

12. A manufacturing method of a device, the method comprising:
manufacturing a louver film by the method of claim 9; and
providing the louver film as a part of the device.

13. A device comprising the louver film of claim 2.

14. A device comprising the louver film of claim 3.

15. A device comprising the louver film of claim 4.

16. A device comprising the louver film of claim 5.

17. A device comprising the louver film of claim 6.

18. A device comprising the louver film of claim 7.

19. A manufacturing method of a device, the method comprising:
manufacturing a louver film by the method of claim 10; and
providing the louver film as a part of the device.

20. A manufacturing method of a device, the method comprising:
manufacturing a louver film by the method of claim 11; and
providing the louver film as a part of the device.
